(19) United States
(12) Patent Application Publication
(10) Pub. No.: US 2025/0024436 A1
(43) Pub. Date: Jan. 16, 2025

(54) UPLINK TRANSMISSION ON SSB SYMBOLS

(71) Applicant: QUALCOMM Incorporated, San Diego, CA (US)

(72) Inventors: Qian ZHANG, Basking Ridge, NJ (US); Yan ZHOU, San Diego, CA (US)

(21) Appl. No.: 18/353,007

(22) Filed: Jul. 14, 2023

(51) Int. Cl. H04W 72/0446; H04L 5/14; H04W 48/08

(52) U.S. Cl. CPC H04W 72/0446; H04L 5/14; H04W 48/08

(57) ABSTRACT

A UE may receive a time resource pattern including a first set of time resources and a second set of time resources that are non-overlapping in a time domain with the first set of time resources, each time resource of the first set of time resources configured with a subband full-duplex (SBFD) configuration, and each time resource of the second set of time resources configured with a non-SBFD configuration. A UE may receive a synchronization signal block (SSB) configuration including one or more periodic SSB occasions. A UE may adjust at least one of an SSB measurement or an uplink transmission in one or more symbols including an SSB occasion, of the one or more periodic SSB occasions, overlapping with a time resource of the first set of time resources.

### INTRODUCTION

The present disclosure relates generally to communication systems, and more particularly, to wireless communication including sub-band full-duplex resources.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method includes receiving a time resource pattern including a first set of time resources and a second set of time resources that are non-overlapping in a time domain with the first set of time resources, each time resource of the first set of time resources configured with a subband full-duplex (SBFD) configuration, and each time resource of the second set of time resources configured with a non-SBFD configuration; receiving a synchronization signal block (SSB) configuration including one or more periodic SSB occasions; and adjusting at least one of an SSB measurement or an uplink transmission in one or more symbols including an SSB occasion, of the one or more periodic SSB occasions, overlapping with a time resource of the first set of time resources.

In an aspect of the disclosure, an apparatus for wireless communication at a UE is provided. The apparatus includes one or more memories and one or more processors coupled to the one or more memories. Based at least in part on information stored in the one or more memories, the one or more processors, individually or in any combination, are configured to cause the UE to receive a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; receive an SSB configuration including one or more periodic SSB occasions; and adjust at least one of an SSB measurement or an uplink transmission in one or more symbols including an SSB occasion, of the one or more periodic SSB occasions, overlapping with a time resource of the first set of time resources.

In an aspect of the disclosure, an apparatus for wireless communication at a UE is provided. The apparatus includes means for receiving a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; means for receiving an SSB configuration including one or more periodic SSB occasions; and means for adjusting at least one of an SSB measurement or an uplink transmission in one or more symbols including an SSB occasion, of the one or more periodic SSB occasions, overlapping with a time resource of the first set of time resources.

In an aspect of the disclosure, a computer-readable storage medium (e.g., a non-transitory computer-readable storage medium) is provided, the computer-readable storage medium storing computer executable code at a UE, the code when executed by one or more processors causes the UE to receive a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; receive an SSB configuration including one or more periodic SSB occasions; and adjust at least one of an SSB measurement or an uplink transmission in one or more symbols including an SSB occasion, of the one or more periodic SSB occasions, overlapping with a time resource of the first set of time resources.

In an aspect of the disclosure, a method of wireless communication at a network node is provided. The method includes configuring a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; providing an SSB configuration including one or more periodic SSB occasions; and adjusting an SSB operation or an SBFD operation in one or more symbols including an SSB occasion overlapping with reception of an uplink transmission of the first set of time resources.

In an aspect of the disclosure, an apparatus for wireless communication at a network node is provided. The apparatus includes one or more memories and one or more processors coupled to the one or more memories. Based at least in part on information stored in the one or more memories, the one or more processors, individually or in any combination, are configured to cause the network node to configure a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; provide an SSB configuration including one or more periodic SSB occasions; and adjust an SSB operation or an SBFD operation in one or more symbols including an SSB occasion overlapping with reception of an uplink transmission of the first set of time resources.

In an aspect of the disclosure, an apparatus for wireless communication at a network node is provided. The apparatus includes means for configuring a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; means for providing an SSB configuration including one or more periodic SSB occasions; and means for adjusting an SSB operation or an SBFD operation in one or more symbols including an SSB occasion overlapping with reception of an uplink transmission of the first set of time resources.

In an aspect of the disclosure, a computer-readable storage medium (e.g., a non-transitory computer-readable storage medium) is provided, the computer-readable storage medium storing computer executable code at a network node, the code when executed by one or more processors causes the network node to configure a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; provide an SSB configuration including one or more periodic SSB occasions; and adjust an SSB operation or an SBFD operation in one or more symbols including an SSB occasion overlapping with reception of an uplink transmission of the first set of time resources.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with aspects presented herein.

FIG. 2 is a diagram illustrating an example of a wireless communications system and an access network, in accordance with aspects presented herein.

FIG. 3A is a diagram illustrating an example of a first frame, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink (UL) channels within a subframe, in accordance with various aspects of the present disclosure.

FIG. 4 is a diagram illustrating an example of a base station and user equipment (UE) in an access network, in accordance with aspects presented herein.

FIGS. 5A, 5B, 5C, and 5D illustrate various modes of full duplex communication, in accordance with aspects presented herein.

FIG. 6A and FIG. 6B illustrate example of in-band full-duplex (IBFD) and sub-band frequency divisional duplex resources, in accordance with aspects presented herein.

FIG. 6C illustrates an example of sub-band frequency divisional duplex resources, in accordance with aspects presented herein.

FIG. 7A. FIG. 7B, and FIG. 7C include diagrams illustrating example aspects of SBFD operation, in accordance with aspects presented herein.

FIG. 8A is a time and frequency diagram including SBFD resources that overlap with an SSB occasion, in accordance with aspects presented herein.

FIG. 8B illustrates an example time resource pattern including SBFD resources, in accordance with aspects presented herein.

FIG. 9A is a time and frequency diagram including SBFD resources that overlap with an SSB occasion, in accordance with aspects presented herein.

FIG. 9B is a time and frequency diagram including SBFD resources that overlap with an SSB occasion, in accordance with aspects presented herein.

FIG. 10A is a time and frequency diagram including SBFD resources that overlap with an SSB occasion, in accordance with aspects presented herein.

FIG. 10B is a time and frequency diagram including SBFD resources that overlap with an SSB occasion, in accordance with aspects presented herein.

FIG. 11 is a time and frequency diagram including SBFD resources that overlap with an SSB occasion, in accordance with aspects presented herein.

FIG. 12 is a time and frequency diagram including SBFD resources that overlap with an SSB occasion, in accordance with aspects presented herein.

FIG. 13 is a communication flow between a UE and a network node, in accordance with aspects presented herein.

FIG. 14 is a flowchart of a method of wireless communication at UE, in accordance with aspects presented herein.

FIG. 15 is a diagram illustrating an example of a hardware implementation for an example apparatus and/or UE.

FIG. 16 is a flowchart of a method of wireless communication at network node, in accordance with aspects presented herein.

FIG. 17 is a diagram illustrating an example of a hardware implementation for an example network entity.

### DETAILED DESCRIPTION

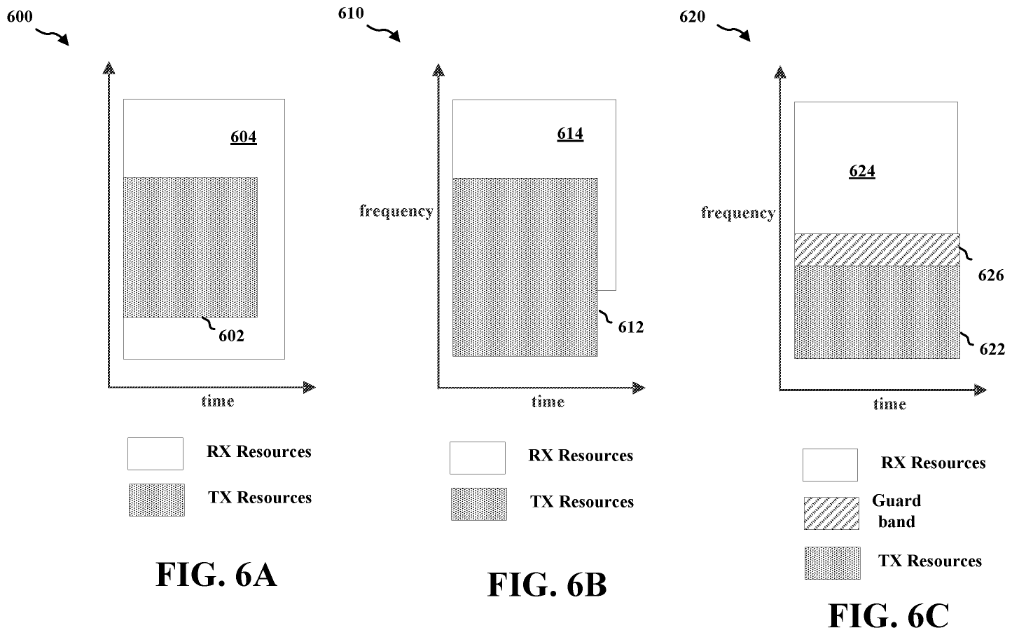

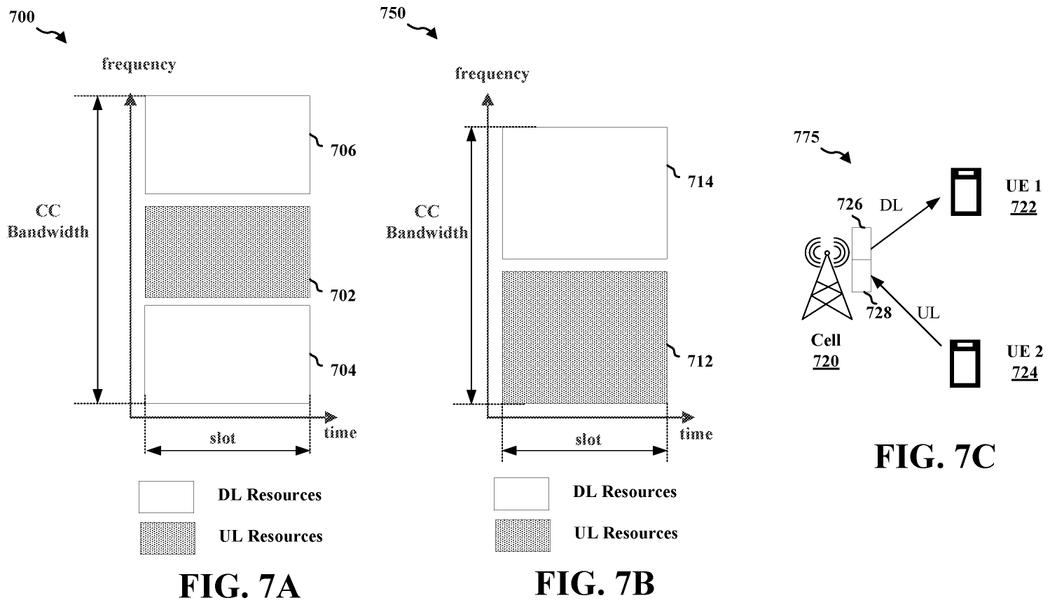

In some aspects, a network node, such as a base station or a component of a base station, may support SBFD communication. In some aspects, a base station may transmit and receive full-duplex communication, and a UE may transmit or receive communication with the base station in a half-duplex manner. In some aspects, a UE may also transmit and receive full-duplex communication. SBFD communication may refer to communication that includes simultaneous transmission and reception in different subbands. Simultaneous transmission and reception may refer to transmission and reception that overlaps at least partially in time. SBFD resources may refer to resources in a time period includes one or more subbands of transmission resources and one or more subbands of reception resources. FIGS. 6C and 7A illustrate examples of SBFD resources. The base station may configure a pattern of time resources to include SBFD resources, e.g., including at least one uplink subband and at least one downlink subband. For example, a time resource pattern may indicate a pattern of time resources as designed for downlink (e.g., D), uplink (e.g., U), special (e.g., S), or SBFD (e.g., SBFD). In some aspects, the pattern may be part of a TDD pattern, e.g., a semi-static TDD pattern that illustrates a pattern of uplink, downlink, flexible, special, and/or SBFD time resources. The time resources may correspond to slots, symbols, etc. The pattern may be configured for use over a period of time, e.g., which may be referred to as a semi-static configuration. In some aspects, the pattern may be referred to as a semi-static SBFD subband time location configuration. Based on the pattern, the network node may allocate or schedule downlink communication in the downlink time resource of the pattern, allocate or schedule uplink communication in the uplink time resource of the pattern, allocate or schedule uplink or downlink communication in the special time resource of the pattern, and allocate or schedule downlink and uplink communication in the SBFD time resource of the pattern.

The base station may also transmit SSB for various measurements at a UE, e.g., such as beam management, beam failure detection, radio link management, radio resource management, and cell selection, among other examples. In some aspects, resources allocated for an uplink transmission in an uplink subband of SBFD resources may fall within a symbol including an SSB occasion. The uplink transmission may affect SSB detection and measurement of other UEs, e.g., by causing interference. Skipping the uplink transmission reduces uplink transmission opportunities and may increase latency. Aspects presented herein enable a UE and a network node to adjust uplink communication and/or SSB transmission or measurement when an uplink transmission would occur in an SSB symbol. An SSB symbol refers to a symbol that includes an SSB occasion. The aspects presented herein enable the UE and base station to determine when to skip an uplink transmission, adjust the resources for the uplink transmission, or skip SSB measurement. In some aspects, the UE and the base station may use a priority rule based on one or more factors to determine whether to prioritize the uplink transmission and/or the SSB. The aspects presented herein improve the efficiency and accuracy of wireless communication by providing conditions to balance the potential for interference with improvements in latency provided by SBFD resources. Enabling a UE to transmit in an SSB symbol can improve uplink performance through additional uplink transmission opportunities. However, the uplink transmission may cause interference to SSB detection and measurement in SSB symbols.

In some aspects, an uplink subband may not be configured in SSB symbols. This may avoid interference caused by a first UE's uplink transmissions in one subband that interferes with a second UE's SSB measurement in a downlink subband. In some aspects, when an SSB occasion would overlap in time with an uplink transmission in an uplink subband, the SSB occasion may be dropped on the SBFD symbols.

Dropping the SSB may avoid interference between the uplink transmission and the SSB, and may allow for reduced latency in the uplink communication by enabling additional uplink time resources. In some aspects, a network node may ensure that no SBFD operation occurs in SSB symbols, e.g., even if periodicities between SSB and an SBFD time are misaligned. In some aspects, a UE may not expect to receive or measure an SSB that would occur in SBFD symbols. By avoiding the SBFD operation in SSB symbols, cross-link interference to the SSB may be avoided or reduced.

In some aspects, an UL subband may be configured in a symbol that includes an SSB occasion, e.g., in an SSB symbol. In some aspects, a UE may not transmit an uplink transmission in an uplink subband in an SSB symbol, e.g., even if the UE is configured or allocated uplink resources. By skipping the transmission, the UE can avoid interference that may be caused to the SSB reception of other UEs. In some aspects, the UE may determine whether or not to drop the transmission based on one or more conditions. As an example, the UE may not transmit the uplink transmission in one or more symbols that include an SSB if the UE is indicated to measure the SSB in the one or more symbols. In some aspects, the UE may transmit the uplink transmission based on the occurrence of one or more conditions. As an example, the condition may be that the UE is not indicated to measure the SSB, that the UE is indicated to drop the SSB measurement, or that the UE is indicated to transmit in SBFD resources, among other examples. In some aspects, the additional condition may help to balance the reduction in interference that can be provided by dropping the uplink transmission in the SSB symbol with the reduction in latency that can occur through the use of SBFD resource for uplink transmission. In some aspects, the UE may receive an indication of a priority to be applied for an SSB and/or uplink transmission when an uplink transmission in SBFD resources occurs in an SSB symbol. The indication may be in one or more of an RRC configuration, a medium access control-control element (MAC-CE), a downlink control information (e.g., a group common DCI (GC DCI), a broadcast, or a UE specific DCI). The indication enables the network greater flexibility in controlling potential interference and latency in communication by determining and indicating the priority between the SSB and the uplink transmission. In some aspects, the UE may use a priority rule to determine whether to prioritize the uplink transmission or the SSB. The priority rule may be based one any combination of an SSB type for respective SSB occasions of the one or more symbols, an uplink channel scheduling type for the respective uplink transmissions of the one or more symbols, a reference signal scheduling type of the respective uplink transmissions of the one or more symbols, a measurement type for measurement of the respective SSBs of the one or more symbols, a cell type associated with the respective SSBs of the one or more symbols, an uplink transmission type of the respective uplink transmissions of the one or more symbols, a content type for the respective uplink transmissions of the one or more symbols, a physical channel type for the respective uplink transmissions of the one or more symbols, a quality of service (QOS) for the respective uplink transmissions of the one or more symbols, or an indication from the network node. The consideration of the priority rule may help to protect some SSB occasions from interference while allowing for latency reduction in uplink communication in some circumstances. In some aspects, the UE may determine whether to transmit the uplink transmission based on a frequency separation between the SSB and the uplink transmission. The consideration of the frequency separation may help enable latency reduction in circumstances in which the transmission may cause less interference to the SSB. The consideration of the separation helps to balance the interference reduction with the latency reduction.

In some aspects, the SSB may overlap with a guard band and/or an uplink subband. In some aspects, the UE may adjust the guard band based on the location of the SSB to provide an added frequency separation between the SSB and the uplink transmission. The UE may then transmit the uplink transmission in the remaining resources after removing the added subband resources. The adjustment of the guard band helps to protect the SSB from interference while still allowing for the uplink transmission in the SBFD resource, e.g., which helps to reduce latency for the uplink transmission.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUS), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

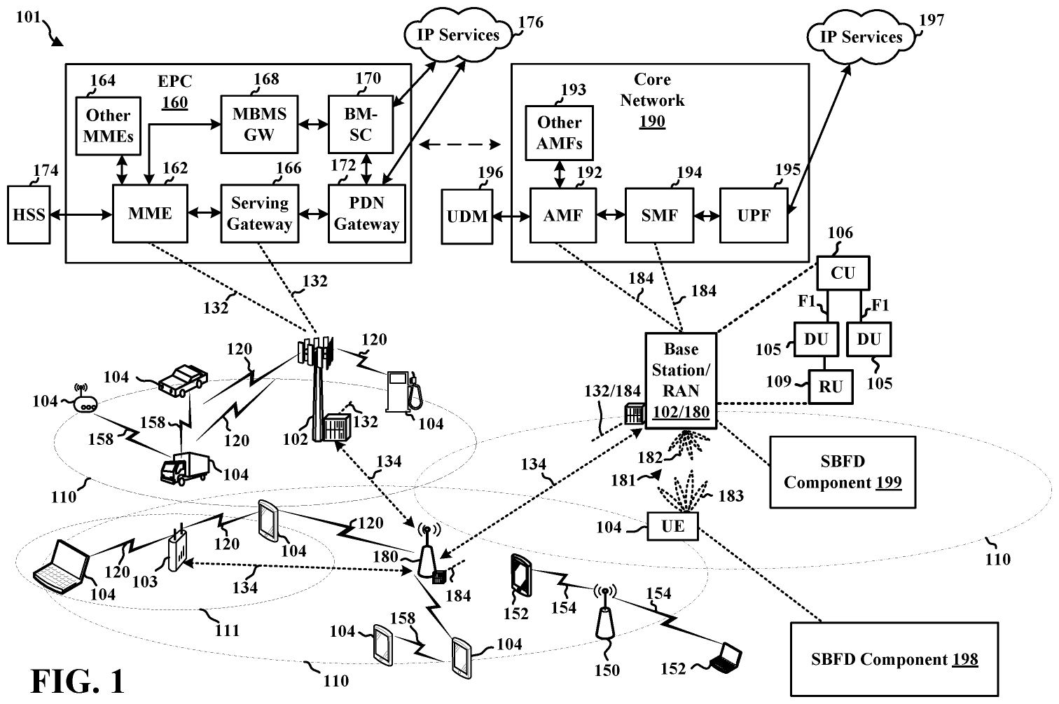

FIG. 1 is a diagram illustrating an example of a wireless communications system and an access network 101. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell 103 may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 103 may operate in a licensed and/or an unlicensed frequency spectrum. When operating in an unlicensed frequency spectrum, the small cell 103 may employ NR and use the same unlicensed frequency spectrum (e.g., 5 GHZ, or the like) as used by the Wi-Fi AP 150. The small cell 103, employing NR in an unlicensed frequency spectrum, may boost coverage to and/or increase capacity of the access network. The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell 103 or a large cell (e.g., a macro base station), may include and/or be referred to as an eNB, gNodeB (gNB), or another type of base station. Some base stations, such as a gNB, may operate in a traditional sub 6 GHZ spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 181 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 182. The UEs 104 may receive the beamformed signal from the base stations 180 in one or more receive directions 183. The UEs 104 may also transmit a beamformed signal to the base stations 180 in one or more transmit directions. The base stations 180 may receive the beamformed signal from the UEs 104 in one or more receive directions. The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, cNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a network entity, such as one of the UEs 104 in communication with one of the base stations 102 or a component of a base station (e.g., a CU 106, a DU 105, and/or an RU 109), may support awareness of SBFD operation at the network node and/or SBFD configurations of resources. For example, one of the UEs 104 may have an SBFD component 198 that may be configured to receive a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; receive an SSB configuration including one or more periodic SSB occasions; and adjust at least one of an SSB measurement or an uplink transmission in one or more symbols including an SSB occasion, of the one or more periodic SSB occasions, overlapping with a time resource of the first set of time resources.

In another configuration, a network entity, such as one of the base stations 102 or a component of a base station (e.g., a CU 106, a DU 105, and/or an RU 109), may support SBFD communication in some resources. For example, one of the base stations 102 may have an SBFD component 199 that may be configured to configure a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; provide an SSB configuration including one or more periodic SSB occasions; and adjust an SSB operation or an SBFD operation in one or more symbols including an SSB occasion overlapping with reception of an uplink transmission of the first set of time resources.

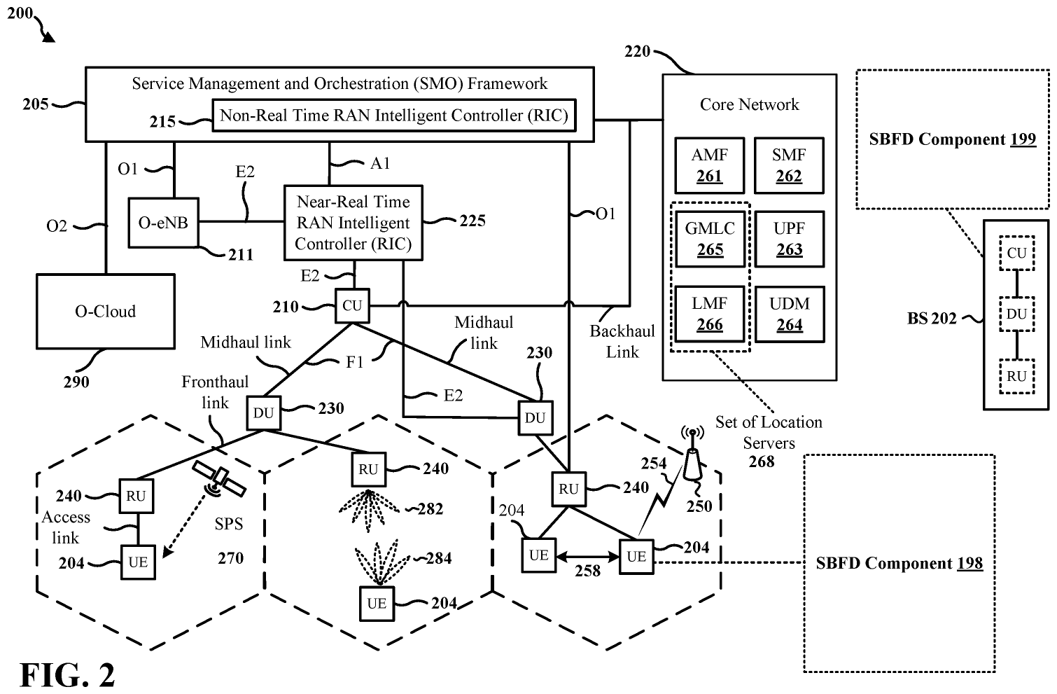

FIG. 2 is a diagram 200 illustrating an example of a wireless communications system and an access network. The illustrated wireless communications system includes a disaggregated base station architecture. The disaggregated base station architecture may include one or more CUs 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 204 via one or more radio frequency (RF) access links. In some implementations, the UE 204 may be simultaneously served by multiple RUs 240. Each of the units, i.e., the CUs 210, the DUs 230, the RUs 240, as well as the Near-RT RICs 225, the Non-RT RICs 215, and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 204. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-cNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The base station 202 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 240 and the UEs 204 may include uplink (UL) (also referred to as reverse link) transmissions from a UE 204 to an RU 240 and/or downlink (DL) (also referred to as forward link) transmissions from an RU 240 to a UE 204. The communication links may use multiple-input and multiple-output (MIMO) antenna technology, including spatial multiplexing, beamforming, and/or transmit diversity. The communication links may be through one or more carriers. The base station 202/UEs 204 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers.

Certain UEs 204 may communicate with each other using device-to-device (D2D) communication link 258, e.g., as described in connection with FIG. 1

The wireless communications system may further include a Wi-Fi AP 250 in communication with UEs 204 (also referred to as Wi-Fi stations (STAs)) via communication link 254, e.g., in a 5 GHz unlicensed frequency spectrum or the like. When communicating in an unlicensed frequency spectrum, the UEs 204/AP 250 may perform a clear channel assessment (CCA) prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The base station 202 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 202 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 220 may include an Access and Mobility Management Function (AMF) 261, a Session Management Function (SMF) 262, a User Plane Function (UPF) 263, a Unified Data Management (UDM) 264, one or more location servers 268, and other functional entities. The AMF 261 is the control node that processes the signaling between the UEs 204 and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) 265 and a Location Management Function (LMF) 266. However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 204 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 204 may be referred to as IoT devices (e.g., parking meter, gas pump, toaster, vehicles, heart monitor, etc.). The UE 204 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

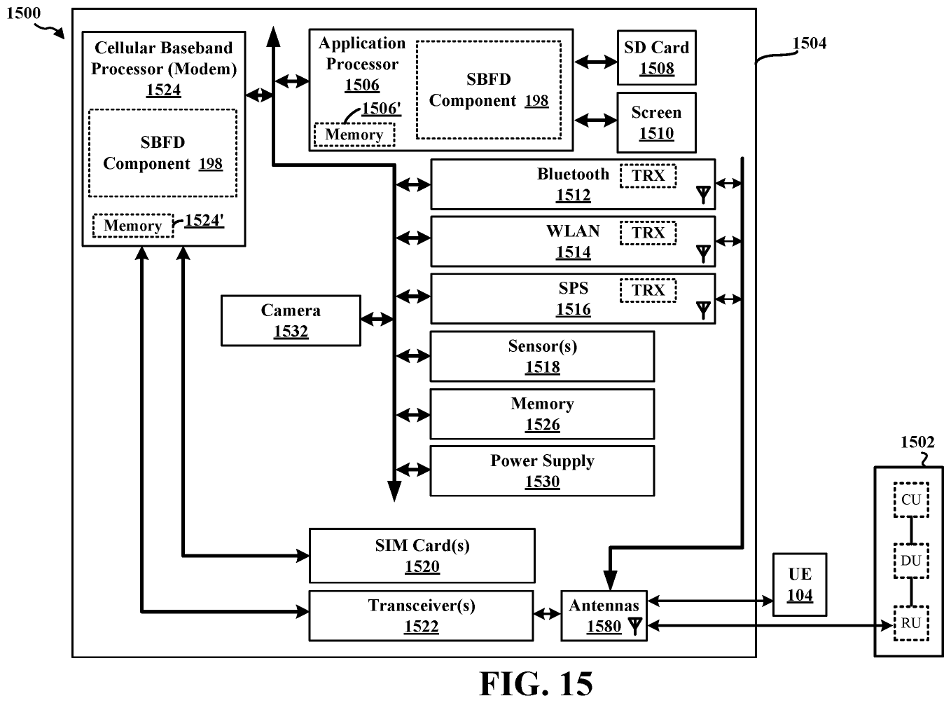

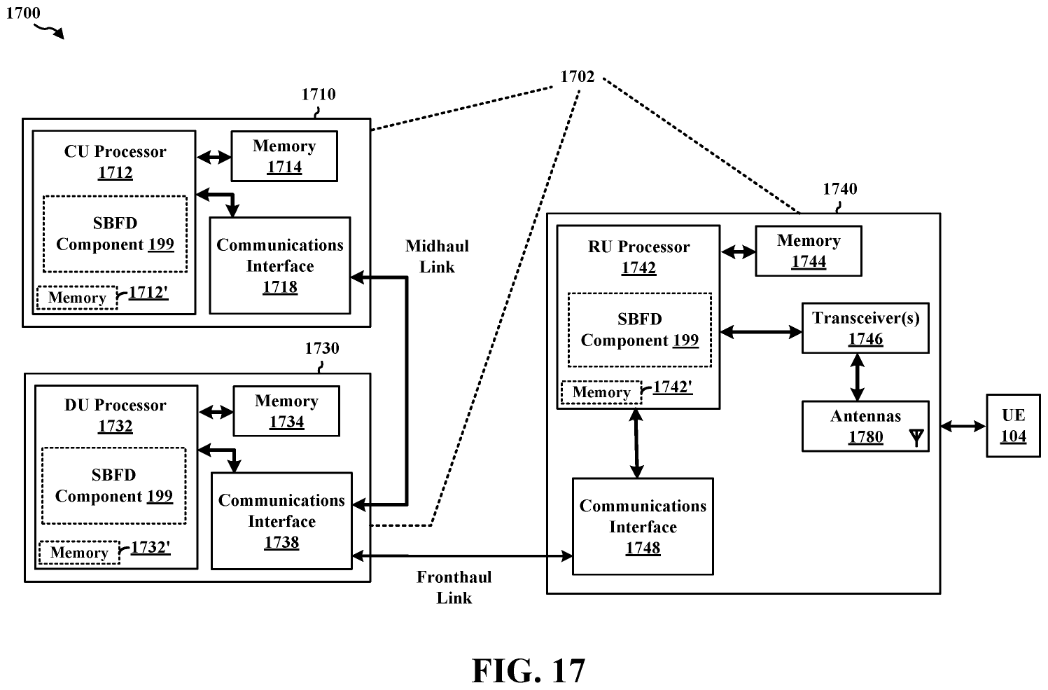

Referring again to FIG. 2, in certain aspects, the UE 204 may have a component 198 that may be configured to perform the aspects described in connection with FIG. 1 and/or FIG. 15. In certain aspects, the base station 202 may have a component 199 that may be configured to perform the aspects described in connection with FIG. 1 and/or FIG. 17.

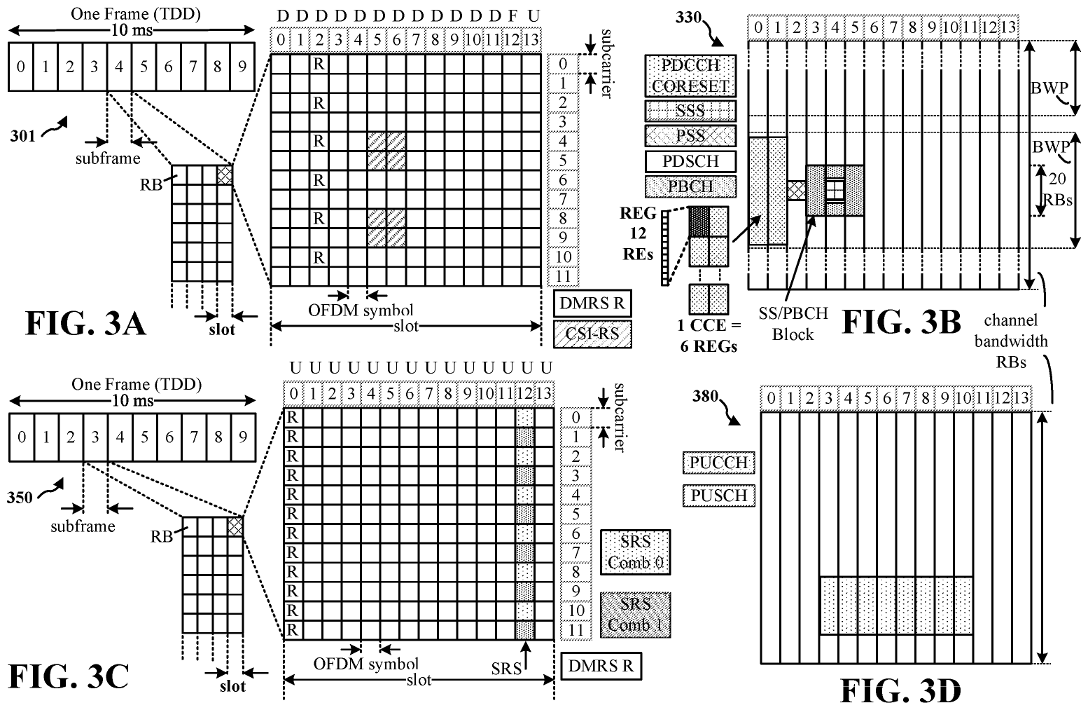

FIG. 3A is a diagram 301 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 204 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

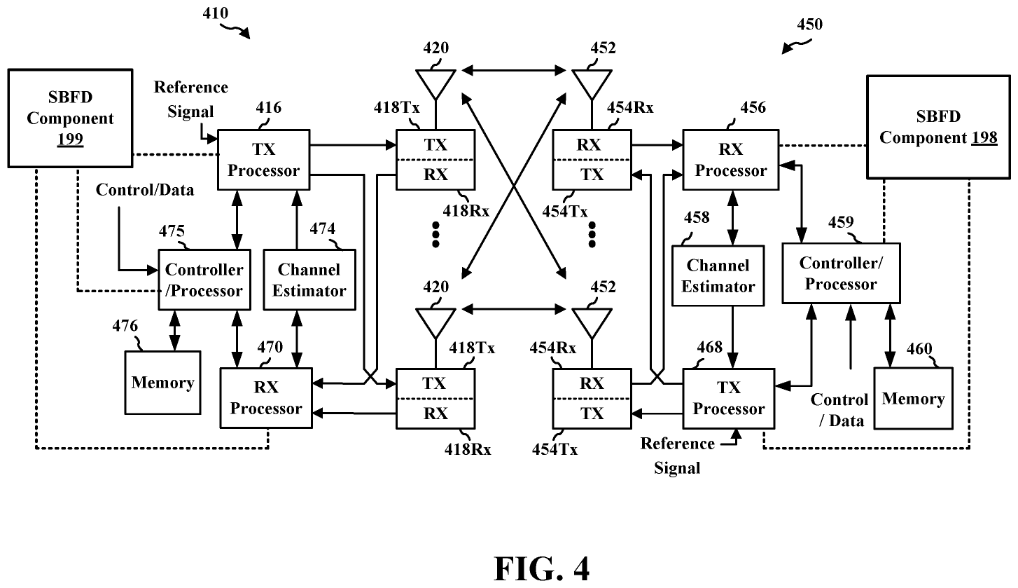

FIG. 4 is a block diagram of a base station 410 in communication with a UE 450 in an access network. In the DL, Internet protocol (IP) packets may be provided to a controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418Tx. Each transmitter 418Tx may modulate a radio frequency (RF) carrier with a respective spatial stream for transmission.

At the UE 450, each receiver 454Rx receives a signal through its respective antenna 452. Each receiver 454Rx recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ. priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454Tx. Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna 420. Each receiver 418Rx recovers information modulated onto an RF carrier and provides the information to a RX processor 470.

The controller/processor 475 can be associated with at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the SBFD component 198 of FIG. 1 and/or FIG. 2.

At least one of the TX processor 416, the RX processor 470, and the controller/processor 475 may be configured to perform aspects in connection with the SBFD component 199 of FIG. 1 and/or FIG. 2.

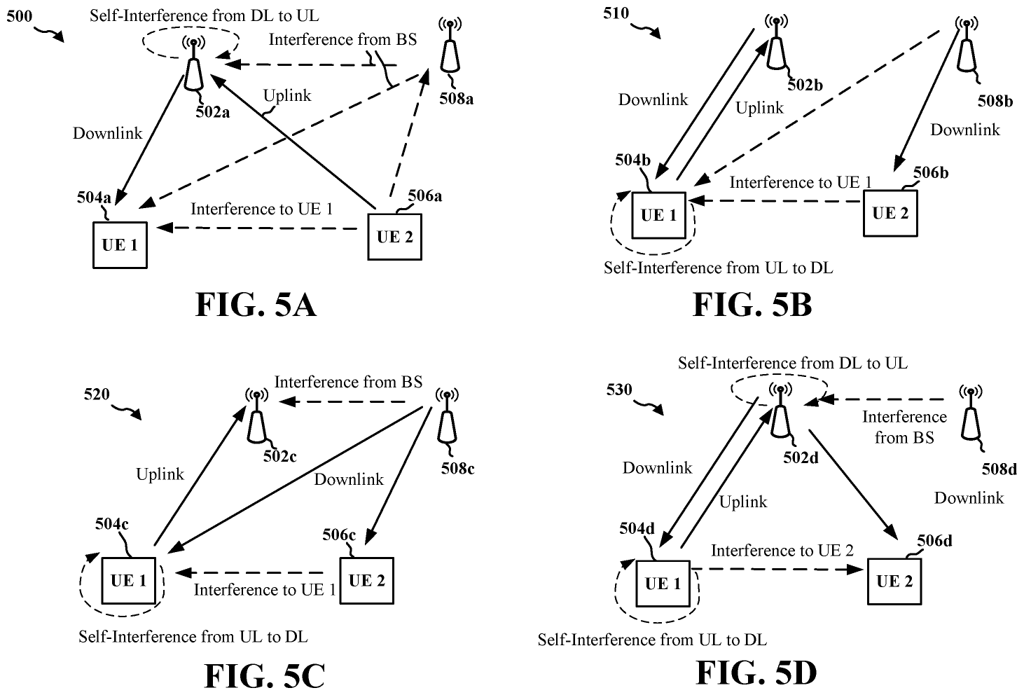

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. As one example, full duplex operation may enable a base station to transmit a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources. A wireless communication system may support full-duplex communication and may also support communication with devices that do not support full-duplex communication. A wireless communication system may include aspects to support co-existence, such as in co-channels and adjacent channels. FIGS. 5A, 5B, 5C, and 5D illustrate various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication. Due to the simultaneous Tx/Rx nature of full duplex communication, a UE or a base station may experience self-interference caused by signal leakage from its local transmitter to its local receiver and/or experienced as clutter from a reflection of the transmitted signal (e.g., due to a reflection from a physical object) that is received as interference to the receiver. In addition, the UE or base station may also experience interference from other devices, such as transmissions from a second UE or a second base station. Such interference (e.g., self-interference or interference caused by other devices) may impact the quality of the communication or even lead to a loss of information.

FIG. 5A shows the first example of full duplex communication 500 in which a first base station 502a is in full duplex communication with a first UE 504a and a second UE 506a. The first UE 504a and the second UE 506a may be configured for half-duplex communication or full-duplex communication. FIG. 5A illustrates the first UE 504a performing downlink reception, and the second UE 506a performing uplink transmission. The second UE 506a may transmit a first uplink signal to the first base station 502a as well as to other base stations, such as a second base station 508a in proximity to the second UE 506a. The first base station 502a transmits a downlink signal to the first UE 504a concurrently (e.g., overlapping at least partially in time) with receiving the uplink signal from the second UE 506a. The base station 502a may experience self-interference at its receiving antenna that is receiving the uplink signal from UE 506a, the self-interference being due to reception of at least part of the downlink signal transmitted to the UE 504a. The base station 502a may experience additional interference due to signals from the second base station 508a. Interference may also occur at the first UE 504a based on signals from the second base station 508a as well as from uplink signals from the second UE 506a.

FIG. 5B shows the second example of full-duplex communication 510 in which a first base station 502b is in full-duplex communication with a first UE 504b. In this example, the UE 504b is also operating in a full-duplex mode. The first base station 502b and the UE 504b receive and transmit communication that overlaps in time and is in the same frequency band. The base station and the UE may each experience self-interference, due to a transmitted signal from the device leaking to (e.g., being received by) a receiver at the same device. The first UE 504b may experience additional interference based on one or more signals emitted from a second UE 506b and/or a second base station 508b in proximity to the first UE 504b.

FIG. 5C shows the third example of full-duplex communication 520 in which a first UE 504c transmits and receives full-duplex communication with a first base station 502c and a second base station 508c. The first base station 502c and the second base station 508c may serve as multiple transmission and reception points (multi-TRPs) for UL and DL communication with the UE 504c. The second base station 508c may also exchange communication with a second UE 506c. In FIG. 5C, the first UE 504c may transmit an uplink signal to the first base station 502c that overlaps in time with receiving a downlink signal from the second base station 508c. The first UE 504c may experience self-interference as a result of receiving at least a portion of the first signal when receiving the second signal, e.g., the UE's uplink signal to the base station 502c may leak to (e.g., be received by) the UE's receiver when the UE is attempting to receive the signal from the other base station 508c. The first UE 504c may experience additional interference from the second UE 506c.

FIG. 5D shows the fourth example of full-duplex communication 530 in which a first base station 502d employs full-duplex communication with a first UE 504d, and transmits downlink communication to a second UE 506d. In this example, the first UE 504d is operating in a full-duplex mode, and the second UE 506d is operating in a half-duplex mode. The first base station 502d and the first UE 504d receive and transmit communication that overlaps in time and is in the same frequency band. The base station 502d and the first UE 504d may each experience self-interference, due to a transmitted signal from the corresponding device leaking to (e.g., being received by) a receiver at the same device. The base station 502d may further experience cross link interference due to a signal transmitted by the base station 508d. The second UE 506d may experience cross-link interference from the uplink transmission of the first UE 504b when receiving downlink communication from the base station 502d.

Aspects of full-duplex communication may be configured to reduce or avoid interference, such as inter-base station and/or inter-UE CLI, e.g., including intra-subband CLI, inter-subband CLI (e.g., such as in non-overlapping full-duplex communication), and/or inter-operator CLI. Some aspects may be configured to enable adjacent channel co-existence with devices that do not support full-duplex communication.

Full duplex communication may occur in the same frequency band with uplink and downlink communication in different frequency sub-bands, in the same frequency sub-band, or in partially overlapping frequency sub-bands. FIG. 6A illustrates a first example 600, and FIG. 6B illustrates a second example 610 of in-band full-duplex (IBFD) resources. FIG. 6C illustrates a third example 620 of sub-band full-duplex (SBFD) resources. In IBFD communication, signals may be transmitted and received in overlapping times and overlapping in frequency. As shown in the first example 600, a time and a frequency allocation of transmission resources 602 may fully overlap with a time and a frequency allocation of reception resources 604. In the second example 610, a time and a frequency allocation of transmission resources 612 may partially overlap with a time and a frequency of allocation of reception resources 614. IBFD is in contrast to sub-band FDD, where transmission and reception resources may overlap in time using different frequencies, as shown in the third example 620. In the third example 620, the UL, the transmission resources 622 are separated from the reception resources 624 by a guard band 626. The guard band may be frequency resources, or a gap in frequency resources, provided between the transmission resources 622 and the reception resources 624. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”.

If the full-duplex operation is for a UE or a device implementing UE functionality, the transmission resources 602, 612, and 622 may correspond to uplink resources, and the reception resources 604, 614, and 624 may correspond to downlink resources. Alternatively, if the full-duplex operation is for a base station or a device implementing base station functionality, the transmission resources 602, 612, and 622 may correspond to downlink resources, and the reception resources 604, 614, and 624 may correspond to uplink resources.

SBFD operation at a wireless device includes simultaneous Tx/Rx, e.g., of downlink and uplink communication, on a sub-band basis. SBFD communication may increase the uplink duty cycle enabling latency reduction and improvement in uplink coverage. For example, under SBFD, an UL signal may be transmitted in DL slots or flexible slots, and a DL signal may be received in UL slots, leading to latency savings. SBFD may enhance the system capacity, resource utilization, spectrum efficiency, and enable flexible and dynamic UL/DL resource adaption according to UL/DL traffic in a robust manner. FIG. 7A and FIG. 7B are diagrams 700 and 750 illustrating examples of SBFD resources. FIG. 7C is a diagram 775 showing an example of full duplex operation, e.g., such as communication in which a base station uses the SBFD resources illustrated in FIG. 7A or 7B. As shown in FIG. 7C, a cell 720 may have DL communication with one UE (e.g., UE 1 722), and simultaneously have UL communication with another UE (e.g., UE 2 724) on the same slot. For example, a first panel 726 (or a portion of a panel) may transmit the downlink communication to the UE 722, and the cell 720 may receive uplink communication from the UE 724 on a second panel 728 (or a second portion of a panel). In one example, the DL communication with UE 1 722 may utilize RX resources 704, 706, and the UL communication with UE 2 724 may utilize TX resources 702. In another example, the DL communication with UE 1 722 may utilize RX resources 714, and the UL communication with UE 2 724 may utilize TX resources 712. Although the example is illustrated for multiple downlink sub-bands, aspects presented herein may be similarly applied for multiple uplink sub-bands.

In some instances, a PRG may be determined to be a wideband PRG. In some instances, non-contiguous frequency resources across downlink subbands may be allocated which comprise contiguous frequency resources within each downlink subband. Wideband precoding may occur within each downlink subband. In some instances, non-contiguous frequency resources across downlink subbands may not be allocated, such that only contiguous PRBs (e.g., single subband scheduling) when wideband DMRS precoding is utilized.

As described in connection with FIG. 7C, a UE may operate in a half-duplex mode, while a base station communicates in a full-duplex mode. In some aspects, the UE may be aware of the full-duplex communication or operation by the base station. For example, an SBFD aware UE may refer to a UE that is aware of, or supports reception and/or use of information indicating, the full-duplex resources or full-duplex communication by the base station in different subbands.

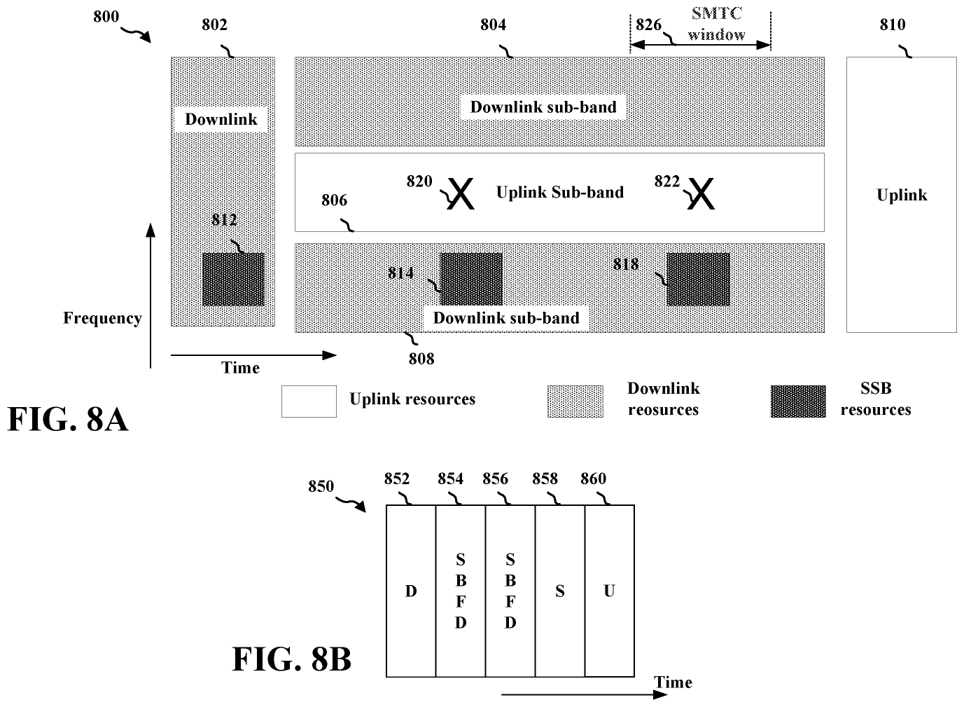

A network node, such as a base station or a component of a base station, may configure resources for transmission of an SSB. FIG. 3C includes an example of an SSB. The network node may also configure or allocate resources for uplink transmissions from UEs. In some aspects, the uplink resources may be provided in an uplink subband of full-duplex resources, e.g., an uplink sub-band, for the network node. As the SSB and semi-static SBFD resources may have different periodicities, there may be instances when an SSB occasion overlaps with a time resource configured for SBFD. Aspects presented herein enable a UE and/or a network node to handle conditions in which an overlap may occur between an SSB occasion in which the network node would transmit an SSB (e.g., in a downlink subband of SBFD resources) and an uplink transmission resource (e.g., in an uplink subband of SBFD resources) in which a UE would transmit an uplink transmission. For example, aspects presented herein provide for a UE and/or network node to adjust uplink communication and/or aspects relating to an SSB when an SSB would overlap in time with SBFD resources. The aspects presented herein enable the network and/or the UE to balance the potential for interference that the uplink transmission may cause to other UEs receiving the SSB from the network node with the potential reduction in latency through SBFD communication in an uplink subband. For example, FIG. 8A illustrates a time and frequency diagram 800 showing that some resources may be configured as half-duplex resources, e.g., such as the downlink period 802 or the uplink period 810, which may each span one or more symbols. Other resources, may be configured as full-duplex resources, e.g., having one or more downlink sub-bands 804 and 808 and one or more uplink sub-bands 806 that overlap in time. The SBFD resources may correspond to one or more symbols. FIG. 8A illustrates that SSB occasions 812, 814, and 818 may occur in the downlink resources. The SSB may be a cell defining SSB (CD-SSB) or a non-cell defining SSB (NCD-SSB), for example. Aspects presented herein address the overlap shown at 820 and 822, e.g., wherein resources for uplink transmission in an uplink sub-band overlap in time with an SSB occasion, e.g., 814 and 818, respectively. A symbol that includes an SSB occasion may be referred to as an SSB symbol. Aspects presented herein address conditions in which uplink resources in an uplink sub-band of resources configured for full-duplex communication would overlap with an SSB symbol.

FIG. 8B illustrates that a time resource pattern 850 may indicate a pattern of time resources for downlink (e.g., D), uplink (e.g., U), special (e.g., S), or SBFD (e.g., SBFD). The SBFD pattern may be configured for use over a period of time, e.g., which may be referred to as a semi-static configuration. In some aspects, the pattern 850 may be referred to as a semi-static SBFD subband time location configuration. In some aspects, the semi-static SBFD subband time location configuration may be part of a TDD pattern, e.g., a semi-static TDD pattern that illustrates a pattern of uplink, downlink, flexible, special and/or SBFD time resources. Each section of the pattern may correspond to one or more slots, one or more symbols, etc. For example, in FIG. For example, a network node may allocate or schedule downlink communication in the downlink time resource 852 of the pattern. The network node may allocate or schedule uplink communication in the uplink time resource 860 of the. The network node may allocate or schedule uplink or downlink pattern. communication in the special time resource 858 of the pattern. For example, a special slot may correspond to a slot that includes both downlink and uplink time resources. As one example, a special slot may include ten downlink symbols, two guard symbols, and two uplink symbols. In the SBFD time resources 854 and 856 of the pattern, the network node may schedule downlink and uplink communication, e.g. with downlink communication in one or more downlink subbands such as 804 and/or 808 and uplink communication in one or more uplink sub-bands such as 806.

In some aspects, the SSB may be scheduled in one of the downlink sub-bands, e.g., and not outside of a downlink sub-band. In some aspects, the SSB can be scheduled in any symbol even outside of a downlink sub-band.

In some aspects, a bitmask may be configured to indicate to a UE whether or not to measure an SSB in SSB occasions. In some aspects, if a bitmask is not configured, then a UE may not be allowed to transmit during a whole SSB measurement timing configuration (SMTC) window 826, which can be up to 5 ms. SBFD provides additional uplink communication opportunities. An overlap between uplink transmission opportunities and SSB may lead to an uplink outage of approximately 5/20 ms=25%, which would impact the latency benefits of SBFD. Aspects presented herein provide conditions under which SSB measurements may be prioritized and/or under which uplink transmission in SSB/SBFD symbols may be prioritized. Aspects presented herein help to address the potential for interference, e.g., CLI from uplink transmissions to SSB measurements of other UEs while balancing improvements in latency with SSB coverage and decoding consistency.

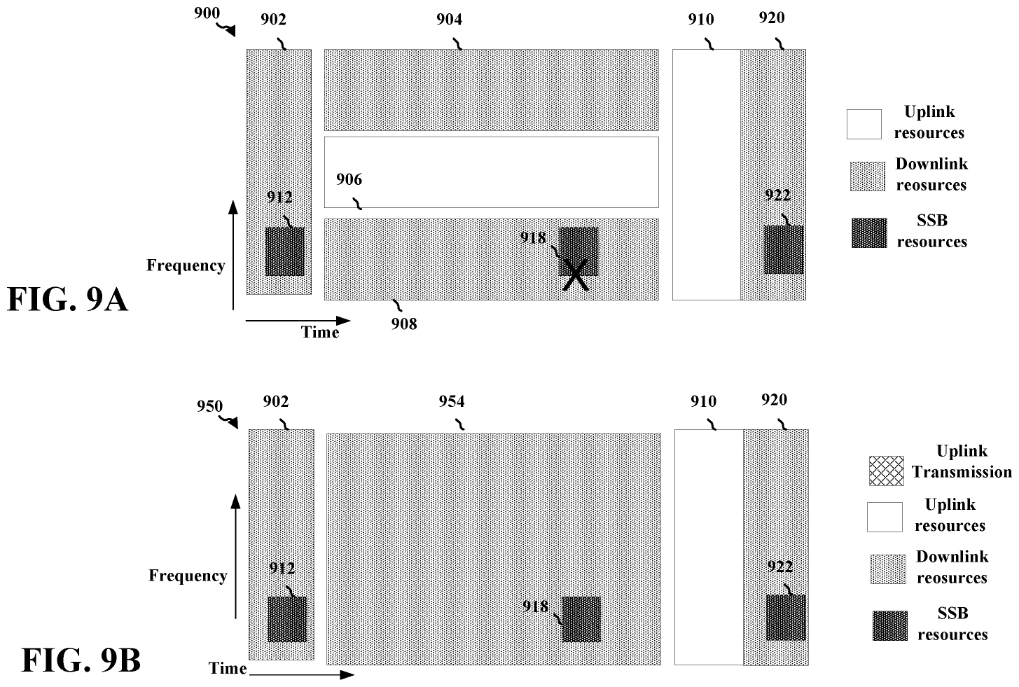

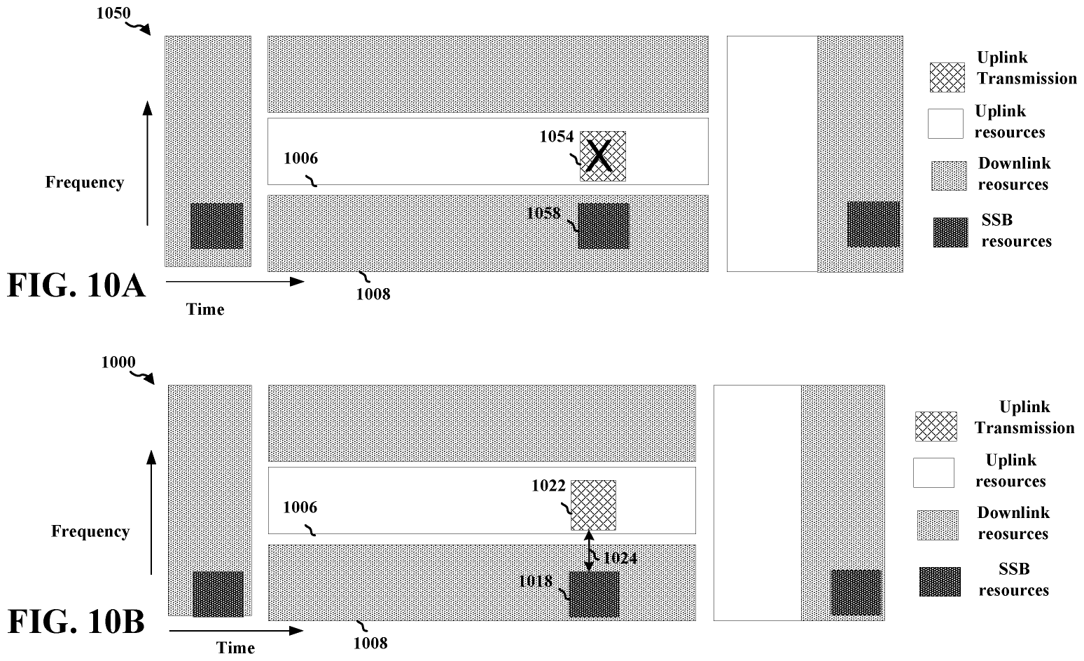

FIGS. 9A, 9B, 10A, and 10B illustrate various examples of an overlap in time between SSB occasions and SBFD resources. Symbols in which an SSB occasion occurs may be referred to as SSB symbols. The SSB symbols may be serving cell SSB symbols (e.g., symbols including an SSB occasion from a cell that is serving a UE) or non-serving cell SSB symbols (e.g., symbols including an SSB occasion from a cell that is not serving a UE).

In some aspects, an uplink subband may not be configured in SSB symbols. For example, the network may not configure an uplink subband that would overlap with one or more symbols that include an SSB occasion. FIG. 9A is a time and frequency diagram 900 showing downlink periods 902 and 920, an uplink period 910, and an SBFD period in which an uplink subband 906 and downlink subbands 904 and 908 are configured. The SSB occasions 912 and 922 occur in the downlink periods 902 and 920. FIG. 9A shows a conflict for the SSB occasion 918 that would occur in the downlink subband 908 of the SBFD period. In some aspects, an uplink subband may not be configured in SSB symbols. For example, FIG. 9B is a time and frequency diagram 950 that illustrates that the time period may be configured for downlink communication, as shown at 954, based on the presence of the SSB occasion 918.

In some aspects, periodicities between SSB occasions and a semi-static SBFD subband time location configuration (e.g., such as shown in FIG. 8B) are misaligned so that SSB occasions may occur in an SBFD symbol. When such an overlap occurs, in some aspects, the SSB occasion may be dropped on the SBFD symbols. For example, in FIG. 9A, the SSB occasion 918 may be dropped. For example, the network node may skip transmission of an SSB in the SSB occasion 918 and/or a UE may skip measurement of an SSB in the SSB occasion 918.

In some aspects, a network node may ensure that no SBFD operation occurs in SSB symbols, even if periodicities between SSB and semi-static SBFD subband time location configuration are misaligned. For example, a UE may not expect to receive or measure an SSB that would occur in SBFD symbols.

In some aspects, an UL subband may be configured in a symbol that includes an SSB occasion, e.g., in an SSB symbol. In some aspects, an SBFD-aware UE may not transmit an uplink transmission in an uplink subband in any SSB symbols. An SBFD-aware UE may refer to a UE that supports reception of information about the SBFD operation of a network node. For example, the SBFD UE may receive information that indicates that the uplink subband 1006 in FIG. 10A is in a time period configured for SBFD operation at the network node. FIG. 10A illustrates a time and frequency diagram 1050 showing an uplink transmission 1054 in an uplink subband 1006 that would overlap in time with an SSB occasion in the downlink subband 1008 (e.g., occur in an SSB symbol). As shown in FIG. 10A, in some aspects, the UE may not transmit the uplink transmission 1054 in the uplink subband 1006 in one or more symbols that also include the SSB occasion, e.g., for the SSB 1058. The UE may have been allocated uplink resources for the uplink transmission, yet may skip the uplink transmission in the one or more symbols that overlap with the SSB occasion. In some aspects, the UE may skip transmission of the uplink transmission based on at least a part of the uplink transmission occurring in a symbol that includes the SSB in a downlink subband. In some aspects, the UE may adjust the uplink transmission to not transmit in a symbols that includes the SSB in the downlink subband.

In some aspects, when an SBFD-aware UE is indicated to measure an SSB (e.g., that occurs in one or more SSB symbols), the UE may not transmit in the uplink transmission 1054 in the uplink subband 1006 in one or more symbols that include the SSB 1058. For example, the UE may transmit the uplink transmission 1054 that occurs in a same symbol as the SSB 1058 if the UE is not configured to measure the SSB 1058. If the UE is configured to measure the SSB 1058, the UE adjusts the uplink transmission 1054, e.g., either dropping the transmission or not transmitting in symbols in which the SSB 1058 occurs.

In some aspects, the UE may not transmit the uplink transmission 1054 in the uplink subband in one or more symbols in which the SSB 1058 occurs, e.g., even if the UE is not indicated to measure the SSB 1058 in the one or more symbols. By not transmitting the uplink transmission in the SSB symbols, the UE avoids interference to other UEs in the same cell and/or in a neighbor cell, which may be indicated to measure the SSB in the same symbol. The uplink transmission 1054 may cause intra-cell or inter-cell inter-UE CLI for the downlink UE SSB measurements of other UEs.

In some aspects, a SBFD-aware UE may transmit the uplink transmission in an uplink subband in a SSB symbol. FIG. 10B is a time and frequency diagram 1000 showing that a UE may transmit an uplink transmission 1022 in an uplink subband 1006, where the uplink transmission 1022 occurs in a same symbol as an SSB 1018 in a downlink subband 1008. In some aspects, the UE may transmit the uplink transmission based on the occurrence of one or more conditions. As an example, if the UE is not indicated to measure the SSB 1018 in the SSB symbol, which the network indicates per UE, the SBFD-aware UE may transmit the uplink transmission 1022 in the uplink subband 1006 in a SSB symbol, e.g., in a symbol that includes the SSB 1018. As another example, if the UE is indicated to measure the SSB 1018 in the SSB symbol, e.g., which is a per UE indication, and the UE is also configured/scheduled with uplink resources for the uplink transmission 1022, then the UE may drop the SSB measurement of the SSB 1018 and transmit the uplink transmission 1022. As another example, if the UE is indicated to measure the SSB 1018 in the SSB symbol, e.g., which is a per UE indication, and the UE is also configured/scheduled with uplink resources for the uplink transmission 1022, then the UE may drop the uplink transmission (e.g., as shown for 1054) and prioritize SSB measurement of the SSB (e.g., 1058). As another example, if the UE is indicated to measure the SSB 1018 in the SSB symbol, and the UE is also configured/scheduled with uplink resources for the uplink transmission 1022, then the UE may determine whether to drop the SSB measurement (e.g., as shown in FIG. 9A) or transmit the uplink transmission (e.g., as shown in FIGS. 10A and 10B) based on a priority rule. For example, the priority rule may indicate whether the SBFD-aware UE will transmit in the UL subband in an SSB symbol.

For example, the priority rule may be based on any subset or any combination of various factors. In some aspects, the priority rule may be based on an SSB type that would occur in the SSB occasion. The SSB type may be aperiodic (AP), semi-persistent (SP), or periodic (P). As an example, an aperiodic resource may be associated with a higher priority level than a semi-persistent resource and a periodic resource, and the priority relationship may be designated as AP>SP>P. In some aspects, the priority rule may be based on an uplink channel type or a reference signal (RS) type of the uplink transmission (e.g., 1022 or 1054) that would occur in the SSB symbol. An aperiodic transmission may be associated with a higher priority level than a semi-persistent transmission and a periodic transmission, and the priority relationship may be designated as AP>SP>P. As an example, an aperiodic uplink transmission may be prioritized over a periodic SSB. As another example, a semi-persistent uplink transmission may be dropped and an aperiodic SSB may be prioritized.

In some aspects, the priority rule may be based on a downlink SSB measurement type. For example, the SSB may be for different types of SSB measurement, and the UE may prioritize measurement of the SSB different for different types of SSB measurement. As an example, the SSB may be for beam measurement, beam failure detection (BFD) or radio link monitoring (RLM), a pathloss reference signal (PL RS), and/or for radio resource management (RRM). The priority rule may be based on the SSB being for one of beam measurement, BFD, RLM, PL RS, or RRM. In some aspects, SSB measurement for beam management may have a lower priority, SSB measurement for BFD/RLM may have a higher priority, SSB measurement for PL RS may have a lower priority, and SSB measurement for RRM or handover may have a higher priority,

In some aspects, the priority rule may be based on a downlink SSB type, e.g., whether the SSB occasion is for a serving cell SSB or a non-serving cell SSB. In some examples, a serving cell SSB may have a higher priority than a non-serving cell SSB. The priority rule may be based on the SSB being a serving cell SSB or being a non-serving cell SSB. In some aspects, a non-serving SSB may be measured for beam switching purposes, e.g., without a cell RRC configuration change or handover. In some aspects, a non-serving cell SSB may be measured for making serving cell changes. Different SSBs may have different priorities, e.g. a non-serving cell SSB for beam switching measurements may have higher priority than a non-serving cell SSB for serving cell change measurements.

In some aspects, the priority rule may be based on an uplink transmission type (e.g., at 1054 or 1022). For example, the priority rule may be based on the uplink transmission being a reference signal (e.g. such as an SRS) or an uplink channel transmission (e.g. PUCCH, PUSCH, PRACH).

In some aspects, the priority rule may be based on an uplink transmission traffic type or content type for the uplink transmission 1054 or 1022, e.g., whether the uplink transmission is a data transmission or a control transmission. If the uplink transmission is a control transmission, the priority rule may be based on whether the uplink transmission 1022 or 1054 is carrying CSI feedback, L1-RSRP, CLI, SR or ACK/NACK, among other examples.

In some aspects, the priority rule may be based on an uplink physical (PHY) layer priority for the uplink transmission 1022 or 1054, e.g., a PHY priority for a PUCCH, a PUSCH, or QoS class of the uplink transmission.

In some aspects, the priority rule may be based on an indication from the network node to the UE. In some aspects, the network node may provide the UE with an RRC indication of a priority to be applied for the SSB and/or the uplink transmission. As an example, the network node may include a bit (or one or more bits) to indicate that a UE is able to transmit in an uplink subband of a SBFD symbol or slot that is overlapped with a SSB occasion. Alternately, the network node may include a bit (or one or more bits) to indicate the SSB occasions that are not transmitted in an uplink subband, e.g., as an indication for prioritization for respective SSB measurements instead of the respective uplink transmissions. In some aspects, the network node may provide a bitmap of the SSB occasions. The bitmap may indicate occasions in which uplink transmission have a higher priority than the SSB, and non-indicated occasions may include SSB having a higher priority than the uplink transmission. Alternately, the bitmap may indicate SSB occasions having a higher priority than uplink transmissions, and the remaining SSB occasions may have a lower priority than the uplink transmissions. In some aspects, the network node may provide a MAC-CE or DCI indication to the UE. In some aspects, the DCI indication may be in a group common DCI (GC DCI). In some aspects, the indication may be in a UE specific DCI. In some aspects, the indication may be broadcast. The MAC-CE or DCI indication may apply to one or more SSB occasions. For example, the indication may include one or more bits indicating that the UE is able to transmit in an uplink subband of SBFD resources that overlap with an SSB occasion. As another example, the indication may include one or more bits indicating that the UE is not to transmit in the uplink subband of SBFD resources that overlap with the SSB occasion, and the SSB has a higher priority.

As shown in FIG. 10B, the UE may be able to transmit the uplink transmission 1022 in an uplink subband of SBFD resources that include an SSB symbol or SSB occasion. If the network indicates for the UE to measure the SSB 1018 in the SSB symbol (e.g., in a per UE indication) and also indicates (e.g., through scheduling or a configuration) uplink resources for an uplink transmission, the UE may consider a frequency separation between the frequency resources (e.g., RBs) of the uplink resources allocated to the UE and the SSB resources. In some aspects, the UE may further consider the frequency separation in combination with the application of a priority rule as described above.

In some aspects, if the frequency separation 1024 (e.g., RBs) between the uplink resources for the uplink transmission 1022 and SSB resources for the SSB 1018 is larger than a threshold, the UE may transmit the uplink transmission 1022 in the uplink subband 1006. If the frequency separation 1024 is less than the threshold, the UE may not transmit the uplink transmission 1022 in symbols including the SSB 1018. In some aspects, the threshold may be based on a minimal inter-UE CLI impact to the SSB 1018 from potential uplink transmissions to provide frequency isolation between the uplink transmission and the SSB.

In some aspects, if an uplink subband is configured in an SSB symbol, e.g., a symbol including an SSB occasion, a SBFD-aware UE may transmit in the uplink subband based on one or more conditions.

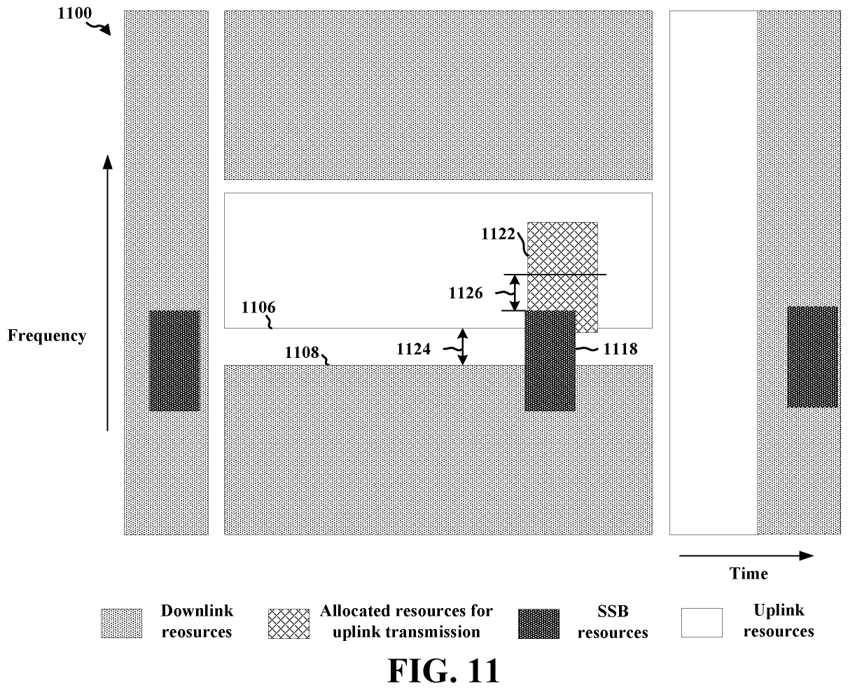

In some aspects, the SSB may overlap with a guard band 1124 (e.g., between an uplink subband 1106 and a downlink subband 1108) as shown in the resource diagram 1100 of FIG. 11. The SSB 1118 may overlap, at least partially, with the uplink subband 1106. In some aspects, an updated guard band location (e.g., 1126) may be determined between the SSB 1118 and an uplink transmission 1122 based on the SSB location+N RBs extending from the SSB 1118, where N is a positive integer number. The updated guard band 1126 may extend within the uplink subband 1106, and the UE may transmit the uplink transmission 1122 using the remaining RBs of the uplink subband without the updated guard band.

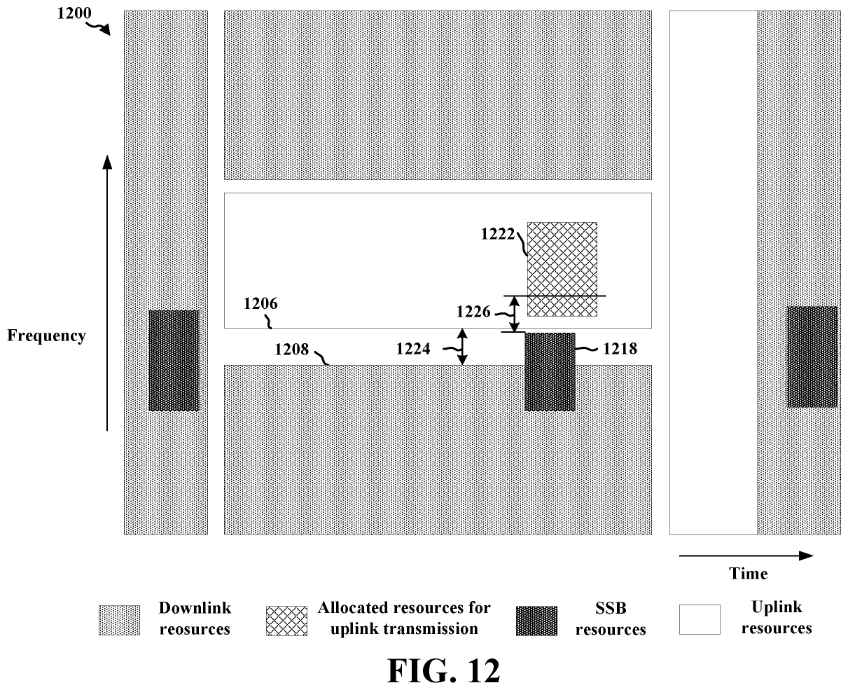

In some aspects, the SSB 1218 may overlap with the guard band 1224 (e.g., between an uplink subband 1206 and a downlink subband 1208) but not with the uplink subband 1206, as shown in the resource diagram 1200 in FIG. 12. An updated guard band location 1226 may be based on the SSB location+N RBs extending into uplink subband 1206. The UE may transmit the uplink transmission 1222 in the remaining RBs of the uplink subband 1206. FIG. 12 illustrates an example in which the SSB 1218 overlaps with the guard band and not with the uplink subband.

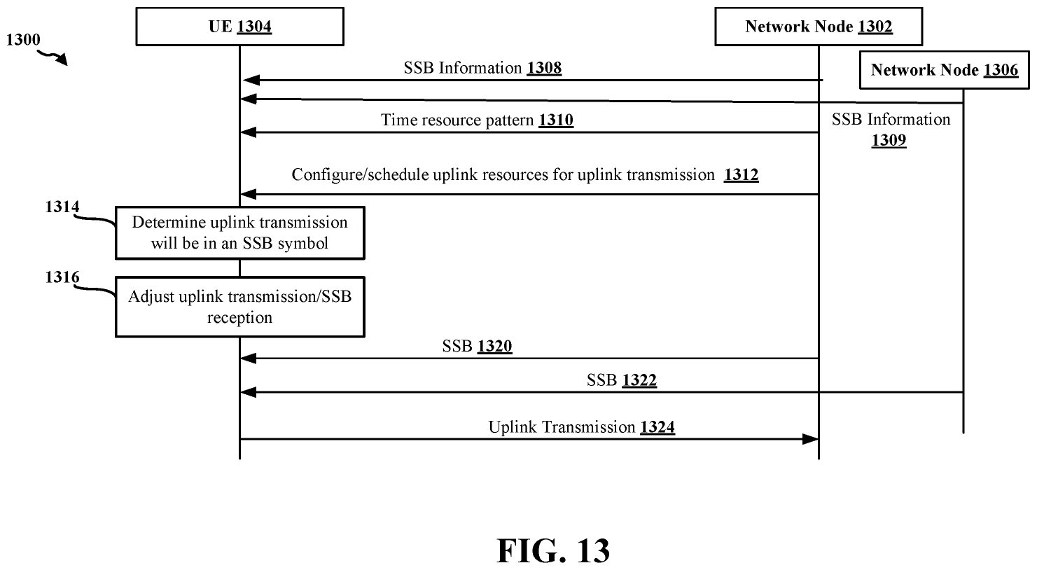

FIG. 13 illustrates an example communication flow 1300 between a UE 1304 and a network node 1302. The network node may be a base station, e.g., a base station in aggregation and/or one or more components of a disaggregated base station such as a CU 210, DU 230 and/or RU 240. The UE may correspond to the UE 104, 204, 450, or the apparatus 1504. The network node 1302 or 1306 may correspond to a base station 102, 202, 410, or the network entity 1702. As shown at 1310, the UE may receive a time resource pattern indicating a first set of time resources and a second set of time resources that are non-overlapping in a time domain with the first set of time resources. The first set of time resources may be configured with an SBFD configuration (e.g., SBFD slots or symbols), and each time resource of the second set of time resources may be configured with a non-SBFD configuration (e.g., D. U, or S slots or symbols), e.g., such as illustrated in any of the various examples in FIGS. 8A-12. For example, the time resource pattern may indicate a pattern of half-duplex time resources and full-duplex time resources (e.g., SBFD time resources). In some aspects, the SBFD time resources may be configured with one or more downlink subbands and one or more uplink subbands that the network node 1302 may use for the transmission of downlink communication and the reception of uplink communication in a full-duplex mode. In some aspects, a UE may communication with the network in a half-duplex mode, e.g., either transmitting uplink transmissions or receiving downlink transmissions without transmitting and receiving simultaneously. The UE 1304 may be a SBFD aware UE, and may support one or more features based on a knowledge of the SBFD operation of the network node 1302. As illustrated at 1308, the UE 1304 may also receive SSB information, such as a configuration associated with an SSB 1320. The SSB may be a periodic SSB with periodic SSB occasions. The SSB may be a semi-persistent SSB with periodic SSB occasions for a semi-persistent duration. The SSB may be an aperiodic SSB. The SSB may be for a serving cell. In some aspects, the SSB may be for a non-serving cell. As shown at 1309, a non-serving cell (e.g., network node 1306) may provide SSB information about an SSB 1322. In some aspects, the SSB information 1308 may include an SSB measurement configuration for the UE 1304.

At 1312, the network node 1302 may allocate or schedule uplink resources for the UE to transmit uplink transmissions to the network node 1302. The allocation may be a configured grant of reoccurring uplink resources, e.g., which may be RRC configured and may be activated via a MAC-CE and/or DCI. The allocation may include a grant of uplink resources in a DCI. The uplink resources may be within an uplink subband of time resources configured as SBFD resources, e.g., as shown in any of FIGS. 9B-12.

In some aspects, as illustrated at 1314, the UE 1304 may determine that an uplink transmission based on the configured or scheduled uplink resources would overlap in time with an SSB occasion, e.g., an SSB symbol. In some aspects, as shown at 1316, the UE may adjust the uplink transmission or SSB reception, e.g., as described in connection with any of the examples in FIGS. 9A-12. For example, the UE may use a prioritization rule to determine whether to transmit or drop the uplink transmission, or to measure the SSB. In some aspects, the UE 1304 may transmit the uplink transmission 1324, e.g., which may correspond to any of 1022, 1122, or 1222, for example.

In some aspects, the network node 1302 may allocate resources to avoid SBFD operation in SSB symbols, e.g., as described in connection with FIGS. 9A and 9B. The UE 1304 may not expect to receive or measure SSB symbols in SBFD symbols, for example. The base station may not schedule an uplink transmission that would overlap with an SSB.

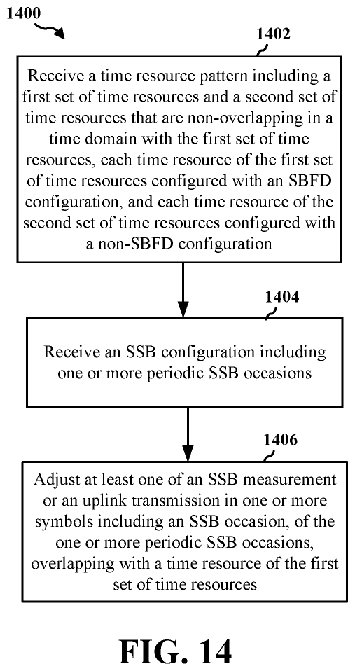

FIG. 14 is a flowchart 1400 of a method of wireless communication. The method may be performed by a UE (e.g., the UE 104, 204, 450, 724, 1304; the apparatus 1504). The aspects described in connection with the method may be performed, e.g. by the SBFD component 198, as an example. The method may enable a UE to address the potential for overlap between SSB resources and resources for uplink transmission, e.g., based on full duplex operation of a network node. By enabling the UE to address the overlap, aspects may improve the accuracy of communication, reduce interference, and help to enable the increased efficiency and reduced latency through support of full-duplex communication at a network node.

At 1402, the UE receives a time resource pattern including a first set of time resources and a second set of time resources that are non-overlapping in a time domain with the first set of time resources. Each time resource of the first set of time resources are configured with an SBFD configuration, and each time resource of the second set of time resources configured with a non-SBFD configuration. For example, 1402 may be performed by the SBFD component 198. FIG. 8B illustrates an example of a time resource pattern, and FIG. 13 illustrates an example of a UE 1304 receiving a time resource pattern, at 1310. The first set of time resources may be referred to as SBFD symbols, and may correspond to time periods in which the network node performs simultaneous uplink and downlink communication, e.g., SBFD communication. Thus, the SBFD configuration may be for the SBFD communication of the network node. The UE may communicate based on a half-duplex operation, for example.

At 1404, the UE receives an SSB configuration including one or more periodic SSB occasions. FIG. 3C illustrates example aspects of an SSB. For example, 1402 may be performed by the SBFD component 198. FIG. 13 illustrates an example of a UE 1304 receiving SSB information, e.g., 1308 and/or 1309.

At 1406, the UE adjusts at least one of an SSB measurement or an uplink transmission in one or more symbols including an SSB occasion, of the one or more periodic SSB occasions, overlapping with a time resource of the first set of time resources. For example, 1402 may be performed by the SBFD component 198. FIG. 13 illustrates an examples of a UE 1304 adjusting SSB measurement or uplink transmission, at 1316. The adjustment may include any of the aspects described in connection with any of FIGS. 8A-13.

In some aspects, each SSB occasion of the one or more periodic SSB occasions may be included in the second set of time resources. For example, in some aspects, uplink resources (e.g., an uplink subband) may not be configured in symbols including an SSB. In some aspects, the UE may receive a configuration that avoids SBFD operation of the network node in symbols with an SSB, e.g., and the UE may not expect to receive or measure SSB in SBFD symbols. In some aspects, adjusting the at least one of the SSB measurement or the uplink transmission may include skipping the SSB measurement based on the SSB configuration. For example, the UE may not expect to receive or measure SSB in SBFD symbols.

In some aspects, uplink resources may be configured in a symbol including an SSB. In some aspects, adjustment of the at least one of the SSB measurement or the uplink transmission may include skipping transmission of the uplink transmission in the one or more symbols that include an SSB. In some aspects, adjustment of the at least one of the SSB measurement or the uplink transmission may include skipping transmission of the uplink transmission in a symbol in which a UE is configured to measure an SSB. For example, the UE may receive a configuration to measure respective SSBs in the one or more periodic SSB occasions, and may skip transmission of the uplink transmission in the one or more symbols, e.g., the symbols in which the UE is configured to measure the respective SSBs. In other aspects, the UE may transmit an uplink transmission in a symbol including an SSB symbol, e.g., if the UE is not indicated to measure the SSB. For example, the UE may transmit the uplink transmission in the one or more symbols based on the UE being non-configured to perform the SSB measurement, e.g., one or more symbols including an SSB that the UE is not configured to measure.

In some aspects, the UE may be indicated to measure the SSB in a symbol and may also be configured, or scheduled, to transmit the uplink transmission. For example, the UE may receive a configuration to measure respective SSBs in the one or more periodic SSB occasions and may receive an allocation of one or more uplink subbands to transmit respective uplink transmissions in one or more time resources of the first set of time resources. In some aspects, the UE may transmit the respective uplink transmissions in the one or more symbols and skip the SSB measurement in the one or more symbols. In some aspects, the UE may measure the respective SSBs in the one or more symbols and skip the respective uplink transmissions in the one or more symbols. In some aspects, the UE may prioritize transmission of the respective uplink transmissions in the one or more symbols or measure the respective SSBs in the one or more symbols based on a rule. For example, the rule may be based on one or more of: an SSB type for respective SSB occasions of the one or more symbols, an uplink channel scheduling type for the respective uplink transmissions of the one or more symbols, a reference signal scheduling type of the respective uplink transmissions of the one or more symbols, a measurement type for measurement of the respective SSBs of the one or more symbols, a cell type associated with the respective SSBs of the one or more symbols, an uplink transmission type of the respective uplink transmissions of the one or more symbols, a content type for the respective uplink transmissions of the one or more symbols, a physical channel type for the respective uplink transmissions of the one or more symbols, or a quality of service (QOS) for the respective uplink transmissions of the one or more symbols. For example, the rule may be based on an SSB type for respective SSB occasions of the one or more symbols, e.g., based on whether the SSB type includes one of an aperiodic SSB, a semi-persistent SSB, or a periodic SSB. For example, the rule may be based on an uplink channel scheduling type for the respective uplink transmissions of the one or more symbols, e.g., based on whether the uplink channel scheduling type and the reference signal scheduling type include one of an aperiodic scheduling type, a semi-persistent scheduling type, or a periodic scheduling type. For example, the rule may be based on a measurement type for measurement of the respective SSBs of the one or more symbols, e.g., based on whether the measurement type includes one of beam management, beam failure detection, radio link monitoring. PL, or radio resource management. For example, the rule may be based on a cell type associated with the respective SSBs of the one or more symbols, e.g., based on whether the cell type includes one of a serving cell or a non-serving cell. For example, the rule may be based on an uplink transmission type of the respective uplink transmissions of the one or more symbols, e.g., based on whether the uplink transmission type includes one of a reference signal or a physical uplink channel. For example, the rule may be based on a content type for the respective uplink transmissions of the one or more symbols, e.g., based on whether the content type includes one of data or control information. For example, the rule may be based on a physical channel type for the respective uplink transmissions of the one or more symbols, e.g., based on whether the physical channel type includes one of a PUCCH, a PUSCH, or a PRACH, among other examples. For example, the rule may be based on a QoS for the respective uplink transmissions of the one or more symbols, e.g., based on whether an aperiodic resource is associated with a higher priority level than a semi-persistent resource and a periodic resource. In some aspects, the rule may be based on an indication from a network node. For example, the indication may include one or more of an RRC indication that indicates prioritization for one of measuring the respective SSBs or transmitting the respective uplink transmissions, a MAC-CE indication indicating the prioritization for measuring the respective SSBs or transmitting the respective uplink transmissions, a group common signaling downlink control information (GC DCI), a broadcast message, or a UE specific message such as a UE specific DCI.

In some aspects, to adjust the at least one of the SSB measurement or the uplink transmission, the UE may transmit or skip the respective uplink transmissions in the one or more symbols based, at least in part, on a frequency separation between one or more resource blocks of the uplink transmission and one or more frequency resources of an SSB on each respective symbol. For example, the UE may transmit the uplink transmission if a frequency separation between uplink resources and an SSB resource is at least a threshold separation, and may skip the uplink transmission if the separation is less than the threshold separation. The threshold may help to avoid inter-CLI to an SSB from the uplink transmission when there is less frequency separation. In some aspects, the frequency separation may be considered in connection with a prioritization rule, such as one or more of the example prioritization rules described above.

In some aspects, to adjust the at least one of the SSB measurement or the uplink transmission, the UE may adjust the respective uplink transmissions in the one or more uplink subbands of the one or more symbols based on one or more frequency resources of an SSB overlapping with at least one of a first set of resource blocks of the one or more uplink subbands or a second set of resource blocks of a guard band. A guard band can be indicated to the UE by a network node or implicitly known by UE. For example, the UE may receive an indication of downlink subband(s) and uplink subband, and the remaining RBs between each downlink subband and each uplink subband, may be guard band RBs. In some aspects, the UE may receive an indication of one or more resource blocks of the second set of resource blocks. In some aspects, the UE may receive one or more indications of one or more resource blocks of the first set of resource blocks and a third set of resource blocks of one or more downlink subbands for respective symbols of the one or more symbols, and wherein the second set of resource blocks are located between the first set of resource blocks and the third set of resource blocks in frequency. In some aspects, the SSB may overlap in frequency with a subset of resources of the first set of resource blocks, and to adjust the respective uplink transmissions, the UE may skip transmitting the uplink transmission in resources overlapping with the subset of resources. In some aspects, to adjust the respective uplink transmissions, the UE may skip transmitting the uplink transmission in the second set of resource blocks.

In some aspects, the SSB may be non-overlapping in frequency with the first set of resource blocks and be overlapping with a first subset of resources of the second set of resource blocks. To adjust the respective uplink transmissions, the UE may skip transmitting the uplink transmission in resources overlapping with a second subset of resources of the first set of resource blocks, and respective quantities of resource blocks of the first subset of resources and the second subset of resources being a same quantity. For example, resources for an SSB may overlap with a guard band but not overlap with the resources for the uplink transmission, and a new guard band location may be based on the SSB location plus an added number of RBs that extend into the resources for the uplink transmission. The UE may then transmit the uplink transmission in remaining RBs for the uplink transmission, e.g., after the new guard band is applied.

FIG. 15 is a diagram 1500 illustrating an example of a hardware implementation for an apparatus 1504. The apparatus 1504 may be a UE, a component of a UE, or may implement UE functionality. The UE may correspond to the UE 104, 204, 450, 504a, 504b, 504c, 504d, 722, 724, 1304. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. As illustrated, the apparatus may include a processing system that may be implemented with a bus architecture with any number of interconnecting buses and bridges depending on the specific application of the processing system and the overall design constraints. As illustrated in FIG. 15, a bus may link together various circuits including one or more processors and/or hardware components, represented by the processor (or processing circuitry) e.g., 1524 or 1506, the illustrated components, and the computer-readable medium/memory (or memory circuitry), e.g., 1524′ and/or 1506′. The memory may include multiple memories, such as memory 1524′ and/or 1506′.

In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104, 204, or 450 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 450 and may include the at least one memory 460 and/or at least one of the TX processor 468, the RX processor 456, and the controller/processor 459. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 450 of FIG. 4) and include the additional modules of the apparatus 1504.

As discussed supra, the SBFD component 198 may be configured to receive a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; receive an SSB configuration including one or more periodic SSB occasions; and adjust at least one of an SSB measurement or an uplink transmission in one or more symbols including an SSB occasion, of the one or more periodic SSB occasions, overlapping with a time resource of the first set of time resources. The component may be performed configured to cause the apparatus to perform any of the aspects described in connection with the flowchart in FIG. 14, and/or the aspects performed by the UE in FIG. 13. The SBFD component 198 may be within the cellular baseband processor(s) 1524, the application processor(s) 1506, or both the cellular baseband processor(s) 1524 and the application processor(s) 1506. The SBFD component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving a time resource pattern including a first set of time resources and a second set of time resources that are non-overlapping in a time domain with the first set of time resources, each time resource of the first set of time resources configured with an SBFD configuration, and each time resource of the second set of time resources configured with a non-SBFD configuration; means for receiving an SSB configuration including one or more periodic SSB occasions; and means for adjusting at least one of an SSB measurement or an uplink transmission in one or more symbols including an SSB occasion, of the one or more periodic SSB occasions, overlapping with a time resource of the first set of time resources. In some aspects, the apparatus 1504 may further include means for receiving a configuration to measure respective SSBs in the one or more periodic SSB occasions, wherein adjusting the at least one of the SSB measurement or the uplink transmission includes skipping transmission of the uplink transmission in the one or more symbols. In some aspects, the apparatus 1504 may further include means for transmitting the uplink transmission in the one or more symbols based on the UE being non-configured to perform the SSB measurement. In some aspects, the apparatus 1504 may further include means for receiving a configuration to measure respective SSBs in the one or more periodic SSB occasions; and receiving an allocation of one or more uplink subbands to transmit respective uplink transmissions in one or more time resources of the first set of time resources. In some aspects, the apparatus 1504 may further include means for transmitting the respective uplink transmissions in the one or more symbols, wherein adjusting the at least one of the SSB measurement or the uplink transmission includes skipping the SSB measurement in the one or more symbols. In some aspects, the apparatus 1504 may further include means for measuring the respective SSBs in the one or more symbols, wherein adjusting the at least one of the SSB measurement or the uplink transmission includes skipping the respective uplink transmissions in the one or more symbols. In some aspects, the apparatus 1504 may further include means for prioritizing transmission of the respective uplink transmissions in the one or more symbols or measuring the respective SSBs in the one or more symbols based on a rule. In some aspects, the apparatus 1504 may further include means for adjusting the respective uplink transmissions in the one or more uplink subbands of the one or more symbols based on one or more frequency resources of an SSB overlapping with at least one of a first set of resource blocks of the one or more uplink subbands or a second set of resource blocks of a guard band. In some aspects, the apparatus 1504 may further include means for receiving an indication of one or more resource blocks of the second set of resource blocks. In some aspects, the apparatus 1504 may further include means for receiving one or more indications of one or more resource blocks of the first set of resource blocks and a third set of resource blocks of one or more downlink subbands for respective symbols of the one or more symbols, and wherein the second set of resource blocks are located between the first set of resource blocks and the third set of resource blocks in frequency. The apparatus may include means for performing any of the aspects described in connection with the flowchart in FIG. 14, and/or the aspects performed by the UE in FIG. 13. The means may be the SBFD component 198 of the apparatus 1504 configured to perform the functions recited by the means. As described supra, the apparatus 1504 may include the TX processor 468, the RX processor 456, and the controller/processor 459. As such, in one configuration, the means may be the TX processor 468, the RX processor 456, and/or the controller/processor 459 configured to perform the functions recited by the means.

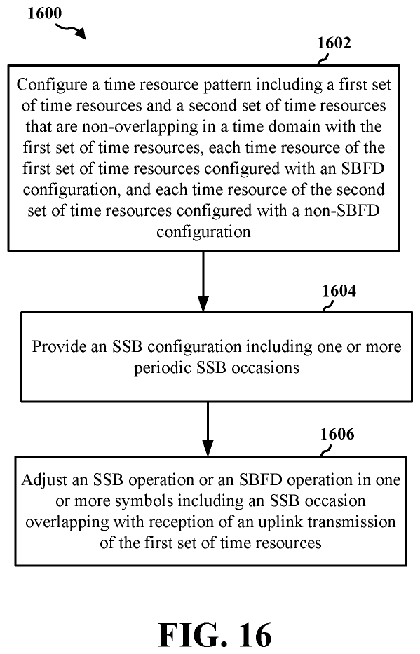

FIG. 16 is a flowchart 1600 of a method of wireless communication. The method may be performed by a base station or a component of a base station (e.g., the base station 102. 202, 410; the network node 1302; the network entity, 1502, 1702; CU 210, DU 230; RU 240). The aspects described in connection with the method may be performed, e.g. by the SBFD component 199, as an example. The method addresses the potential for overlap between SSB resources and resources for uplink transmission, e.g., based on full duplex operation of a network node, and helps to improve the accuracy of communication, reduce interference, and help to enable the increased efficiency and reduced latency through support of full-duplex communication at a network node.

At 1602, the network node configured a time resource pattern including a first set of time resources and a second set of time resources that are non-overlapping in a time domain with the first set of time resources. Each time resource of the first set of time resources may be configured with an SBFD configuration, and each time resource of the second set of time resources may be configured with a non-SBFD configuration. The configuration at 1602 may be performed, e.g., by the SBFD component 199. FIG. 8B illustrates an example of a time resource pattern. FIG. 13 illustrates an example of a network node 1302 providing, e.g., transmitting, a time resource pattern to a UE 1304, at 1310. The first set of time resources may be referred to as SBFD symbols, and may correspond to time periods in which the network node performs simultaneous uplink and downlink communication, e.g., SBFD communication. Thus, the SBFD configuration may be for the SBFD communication of the network node. The UE may communication based on a half-duplex operation, for example.

At 1604, the network node provides an SSB configuration including one or more periodic SSB occasions. The provision of the SSB configuration at 1604 may be performed, e.g., by the SBFD component 199. FIG. 13 illustrates an example of a network node 1302 providing, e.g., transmitting, an SSB configuration to a UE 1304 at 1308.

At 1606, the network node adjusts an SSB operation or an SBFD operation in one or more symbols including an SSB occasion overlapping with reception of an uplink transmission of the first set of time resources. The adjustment at 1606 may be performed, e.g., by the SBFD component 199. The adjustment may include any of the aspects described in connection with FIGS. 8A-13.

In some aspects, each SSB occasion of the one or more periodic SSB occasions may be included in the second set of time resources. For example, in some aspects, uplink resources (e.g., an uplink subband) may not be configured in symbols including an SSB. In some aspects, the network node may provide the UE with a configuration that avoids SBFD operation of the network node in symbols with an SSB, e.g., and may not expect the UE to receive or measure SSB in SBFD symbols. To adjust the SSB operation or the SBFD operation, the network node may skip scheduling of uplink traffic for the one or more symbols. For example, the network node may schedule uplink communication of the UE to avoid symbols including an SSB. To adjust the SSB operation or the SBFD operation, the network node may skip transmission of a respective SSB in each SSB occasion of the one or more symbols. In some aspects, the network node may schedule each SSB occasion of the one or more periodic SSB occasions to respective time resources of the second set of time resources. For example, the network node may avoid SBFD operation in SSB symbols, e.g., even if periodicities between SSB and semi-static SBFD subband time location configuration are misaligned. The network node may not expect the UE to receive or measure SSB in SBFD symbols.

In some aspects, to adjust the SSB operation or the SBFD operation, the network node may configure respective time resources of the first set of time resources to avoid an overlap with each SSB occasion of the SSB configuration. In some aspects, each time resource of the first set of time resources may include one or more uplink subbands and one or more downlink subbands overlapping in the time domain.

In some aspects, the network node may obtain an uplink communication associated with a first UE using the one or more uplink subbands of a first time resource of the time resource pattern; and provide a downlink communication associated with a second UE using the one or more downlink subbands of the first time resource.

In some aspects, the network node may provide an allocation of one or more uplink subbands for a UE for respective uplink transmissions in one or more time resources of the first set of time resources. For example, the network node may configure an uplink subband in a symbol with an SSB. The network node may provide a configuration for the UE to measure respective SSBs in the one or more periodic SSB occasions; and skip the reception of the uplink transmission in the one or more uplink subbands at the one or more symbols. In some aspects, the network node may prioritize SSB measurement in the one or more periodic SSB occasions of the one or more symbols or reception of the uplink transmission based on a rule. For example, the rule may be based on one or more of: an SSB type for respective SSB occasions of the one or more symbols, an uplink channel scheduling type for the respective uplink transmissions of the one or more symbols, a reference signal scheduling type of the respective uplink transmissions of the one or more symbols, a measurement type for measurement of the respective SSBs of the one or more symbols, a cell type associated with the respective SSBs of the one or more symbols, an uplink transmission type of the respective uplink transmissions of the one or more symbols, a content type for the respective uplink transmissions of the one or more symbols, a physical channel type for the respective uplink transmissions of the one or more symbols, or a QoS for the respective uplink transmissions of the one or more symbols. For example, the rule may be based on an SSB type for respective SSB occasions of the one or more symbols, e.g., based on whether the SSB type includes one of an aperiodic SSB, a semi-persistent SSB, or a periodic SSB. For example, the rule may be based on an uplink channel scheduling type for the respective uplink transmissions of the one or more symbols, e.g., based on whether the uplink channel scheduling type and the reference signal scheduling type include one of an aperiodic scheduling type, a semi-persistent scheduling type, or a periodic scheduling type. For example, the rule may be based on a measurement type for measurement of the respective SSBs of the one or more symbols, e.g., based on whether the measurement type includes one of beam management, beam failure detection, radio link monitoring. PL, or radio resource management. For example, the rule may be based on a cell type associated with the respective SSBs of the one or more symbols, e.g., based on whether the cell type includes one of a serving cell or a non-serving cell. For example, the rule may be based on an uplink transmission type of the respective uplink transmissions of the one or more symbols, e.g., based on whether the uplink transmission type includes one of a reference signal or a physical uplink channel. For example, the rule may be based on a content type for the respective uplink transmissions of the one or more symbols, e.g., based on whether the content type includes one of data or control information. For example, the rule may be based on a physical channel type for the respective uplink transmissions of the one or more symbols, e.g., based on whether the physical channel type includes one of a PUCCH, a PUSCH, or a PRACH, among other examples. For example, the rule may be based on a QoS for the respective uplink transmissions of the one or more symbols, e.g., based on whether an aperiodic resource is associated with a higher priority level than a semi-persistent resource and a periodic resource. In some aspects, the rule may be based on an indication from the network node. For example, the indication may include one or more of an RRC indication that indicates prioritization for one of measuring the respective SSBs or transmitting the respective uplink transmissions, a MAC-CE indication indicating the prioritization for measuring the respective SSBs or transmitting the respective uplink transmissions, a GC DCI, a broadcast message, or a UE specific message such as a UE specific DCI. In some aspects, an aperiodic resource may be associated with a higher priority level than a semi-persistent resource and a periodic resource.

In some aspects, the network node may skip the respective uplink transmissions in the one or more symbols based, at least in part, on a frequency separation between one or more resource blocks of the uplink transmission and one or more frequency resources of an SSB on each respective symbol. For example, the network node may receive the uplink transmission if a frequency separation between uplink resources and an SSB resource is at least a threshold separation, and may skip the reception of the uplink transmission, or the scheduling of the uplink transmission, if the separation is less than the threshold separation. The threshold may help to avoid inter-CLI to an SSB from the uplink transmission when there is less frequency separation. In some aspects, the frequency separation may be considered in connection with a prioritization rule, such as one or more of the example prioritization rules described above.

In some aspects, an uplink subband may be configured in an SSB symbol, and a SBFD-aware UE may be allowed to transmit in the uplink subband in a SSB symbol. In some aspects, the network node may provide an allocation of one or more uplink subbands for a UE for respective uplink transmissions in one or more time resources of the first set of time resources, provide a configuration for the UE to measure respective SSBs in the one or more periodic SSB occasions, and adjust respective receptions of uplink transmissions in the one or more uplink subbands of the one or more symbols based on one or more frequency resources of an SSB overlapping with at least a first set of resource blocks of the one or more uplink subbands or a second set of resource blocks of a guard band. The SSB may overlap in frequency with a subset of resources of the first set of resource blocks, and the network node may adjust the respective receptions to skip receiving the uplink transmission in resources overlapping with the subset of resources. In some aspects, to adjust the respective receptions, the network node may skip receiving the uplink transmission in the second set of resource blocks. For example, the SSB may overlap with a guard band and also partially overlap with an uplink subband. A new guard band location may be determined between the SSB and the uplink transmission UL based on SSB location plus a number of RBs extending from the SSB and within uplink subband. The network node may receive the uplink transmission in the remaining RBs of the uplink subband.

In some aspects, the SSB may be non-overlapping in frequency with the first set of resource blocks and be overlapping with a first subset of resources of the second set of resource blocks. To adjust the respective receptions, the network node may skip receiving the uplink transmission in one or more guard band resources based on resources of the SSB. For example, resources for an SSB may overlap with a guard band but not overlap with the resources for the uplink transmission, and a new guard band location may be based on the SSB location plus an added number of RBs that extend into the resources for the uplink transmission. The network node may receive the uplink transmission in the remaining RBs for the uplink transmission, e.g., after the new guard band is applied.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the SBFD component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712 (or processor circuitry). The CU processor(s) 1712 (or processor circuitry) may include on-chip memory 1712′ (or memory circuitry). In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732 (or processor circuitry). The DU processor(s) 1732 (or processor circuitry) may include on-chip memory 1732′ (or memory circuitry). In some aspects, the DU 1730 may further include additional memory modules 1734 and a communications interface 1738. The DU 1730 communicates with the RU 1740 through a fronthaul link. The RU 1740 may include at least one RU processor 1742 (or processor circuitry). The RU processor(s) 1742 (or processor circuitry) may include on-chip memory 1742′ (or memory circuitry). In some aspects, the RU 1740 may further include additional memory modules 1744, one or more transceivers 1746, antennas 1780, and a communications interface 1748. The RU 1740 communicates with the UE 104 or 204. The on-chip memory 1712′, 1732′, 1742′ and the additional memory modules 1714, 1734, 1744 may each be considered a computer-readable medium/memory. Each computer-readable medium/memory may be non-transitory. Each of the processors 1712. 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the SBFD component 199 may be configured to configure a time resource pattern including a first set of time resources and a second set of time resources that are non-overlapping in a time domain with the first set of time resources, each time resource of the first set of time resources configured with a SBFD configuration, and each time resource of the second set of time resources configured with a non-SBFD configuration; provide a synchronization signal block (SSB) configuration including one or more periodic SSB occasions; and adjust an SSB operation or an SBFD operation in one or more symbols including an SSB occasion overlapping with reception of an uplink transmission of the first set of time resources. The SBFD component 199 may be further configured to perform any of the aspects described in connection with the flowchart in FIG. 16 and/or performed by the network node in FIG. 13. The SBFD component 199 may be within one or more processors of one or more of the CU 1710, DU 1730, and the RU 1740. The SBFD component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for configuring a time resource pattern including a first set of time resources and a second set of time resources that are non-overlapping in a time domain with the first set of time resources, each time resource of the first set of time resources configured with a SBFD configuration, and each time resource of the second set of time resources configured with a non-SBFD configuration; means for providing a SSB configuration including one or more periodic SSB occasions; and means for adjusting an SSB operation or an SBFD operation in one or more symbols including an SSB occasion overlapping with reception of an uplink transmission of the first set of time resources. In some aspects, the network node may further include means for scheduling each SSB occasion of the one or more periodic SSB occasions to respective time resources of the second set of time resources. In some aspects, the network node may further include means for configuring respective time resources of the first set of time resources to avoid an overlap with each SSB occasion of the SSB configuration. In some aspects, the network node may further include means for obtaining an uplink communication associated with a first UE using the one or more uplink subbands of a first time resource of the time resource pattern; and means for providing a downlink communication associated with a second UE using the one or more downlink subbands of the first time resource. In some aspects, the network node may further include means for providing an allocation of one or more uplink subbands for a UE for respective uplink transmissions in one or more time resources of the first set of time resources; means for providing a configuration for the UE to measure respective SSBs in the one or more periodic SSB occasions; and means for skipping the reception of the uplink transmission in the one or more uplink subbands at the one or more symbols. In some aspects, the network node may further include means for prioritizing SSB measurement in the one or more periodic SSB occasions of the one or more symbols based on a rule. In some aspects, the network node may further include means for providing an allocation of one or more uplink subbands for a UE for respective uplink transmissions in one or more time resources of the first set of time resources; means for providing a configuration for the UE to measure respective SSBs in the one or more periodic SSB occasions; and means for adjusting respective receptions of uplink transmissions in the one or more uplink subbands of the one or more symbols based on one or more frequency resources of an SSB overlapping with at least a first set of resource blocks of the one or more uplink subbands or a second set of resource blocks of a guard band. The network node may include means for performing any of the aspects described in connection with the flowchart in FIG. 16 and/or performed by the network node in FIG. 13. The means may be the SBFD component 199 of the network entity 1702 configured to perform the functions recited by the means. As described supra, the network entity 1702 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, comprising: receiving a time resource pattern including a first set of time resources and a second set of time resources that are non-overlapping in a time domain with the first set of time resources, each time resource of the first set of time resources configured with a SBFD configuration, and each time resource of the second set of time resources configured with a non-SBFD configuration; receiving a SSB configuration including one or more periodic SSB occasions; and adjusting at least one of an SSB measurement or an uplink transmission in one or more symbols including an SSB occasion, of the one or more periodic SSB occasions, overlapping with a time resource of the first set of time resources.

In aspect 2, the method of aspect 1 further includes that each SSB occasion of the one or more periodic SSB occasions is included in the second set of time resources.

In aspect 3, the method of aspect 1 or aspect 2 further includes that adjusting the at least one of the SSB measurement or the uplink transmission includes skipping the SSB measurement based on the SSB configuration.

In aspect 4, the method of aspect 1 or aspect 2 includes that adjusting the at least one of the SSB measurement or the uplink transmission includes skipping transmission of the uplink transmission in the one or more symbols including the SSB occasion.

In aspect 5, the method of any of aspect 1, 2, or 4 further includes receiving a configuration to measure respective SSBs in the one or more periodic SSB occasions, wherein adjusting the at least one of the SSB measurement or the uplink transmission includes skipping transmission of the uplink transmission in the one or more symbols including the SSB occasion.

In aspect 5, the method of any of aspect 1, 2, or 3 further includes transmitting the uplink transmission in the one or more symbols including the SSB occasion based on the UE being non-configured to perform the SSB measurement.

In aspect 6, the method of any of aspects 1-5 further includes receiving a configuration to measure respective SSBs in the one or more periodic SSB occasions; and receiving an allocation of one or more uplink subbands to transmit respective uplink transmissions in one or more time resources of the first set of time resources.

In aspect 8, the method of aspect 7 further includes transmitting the respective uplink transmissions in the one or more symbols including the SSB occasion, adjusting the at least one of the SSB measurement or the uplink transmission includes skipping the SSB measurement in the one or more symbols.

In aspect 9, the method of aspect 7 further includes measuring the respective SSBs in the one or more symbols including the SSB occasion, wherein adjusting the at least one of the SSB measurement or the uplink transmission includes skipping the respective uplink transmissions in the one or more symbols.

In aspect 10, the method of any of aspects 1-9 further includes prioritizing transmission of the respective uplink transmissions in the one or more symbols or measurement the respective SSBs in the one or more symbols based on a rule.

In aspect 11, the method of aspect 10 further includes that the rule is based on one or more of: an SSB type for respective SSB occasions of the one or more symbols, an uplink channel scheduling type for the respective uplink transmissions of the one or more symbols, a reference signal scheduling type of the respective uplink transmissions of the one or more symbols, a measurement type for measurement of the respective SSBs of the one or more symbols, a cell type associated with the respective SSBs of the one or more symbols, an uplink transmission type of the respective uplink transmissions of the one or more symbols, a content type for the respective uplink transmissions of the one or more symbols, a physical channel type for the respective uplink transmissions of the one or more symbols, or a QoS for the respective uplink transmissions of the one or more symbols.

In aspect 12, the method of aspect 11 further includes that the SSB type includes one of an aperiodic SSB, a semi-persistent SSB, or a periodic SSB.

In aspect 13, the method of aspect 11 or aspect 12 further includes that the uplink channel scheduling type and the reference signal scheduling type include one of an aperiodic scheduling type, a semi-persistent scheduling type, or a periodic scheduling type.

In aspect 14, the method of any of aspects 11-13 further includes that the measurement type includes one of beam management, beam failure detection, radio link monitoring. PL, or radio resource management.

In aspect 15, the method of any of aspects 11-14 further includes that the cell type includes one of a serving cell or a non-serving cell.

In aspect 16, the method of any of aspects 11-15 further includes that the uplink transmission type includes one of a reference signal or a physical uplink channel.

In aspect 17, the method of any of aspects 11-16 further includes that the content type includes one of data or control information.

In aspect 18, the method of any of aspects 11-17 further includes that the physical channel type includes one of a PUCCH, a PUSCH, or a PRACH.

In aspect 19, the method of any of aspects 11-18 further includes that an aperiodic resource is associated with a higher priority level than a semi-persistent resource and a periodic resource.

In aspect 20, the method of any of aspects 10-19 further includes that the rule is based on an indication from a network node.

In aspect 21, the method of aspect 20 further include that the indication includes one or more of: a RRC indication that indicates prioritization for one of measuring the respective SSBs or transmitting the respective uplink transmissions, a MAC-CE indication indicating the prioritization for measuring the respective SSBs or transmitting the respective uplink transmissions, a GC DCI, a broadcast message, or a UE specific DCI.

In aspect 22, the method of any of aspects 7-21 further includes that adjusting the at least one of the SSB measurement or the uplink transmission includes transmitting or skipping the respective uplink transmissions in the one or more symbols is based, at least in part, on a frequency separation between one or more resource blocks of the uplink transmission and one or more frequency resources of an SSB on each respective symbol.

In aspect 23, the method of any of aspects 7-21 further includes that adjusting the at least one of the SSB measurement or the uplink transmission includes adjusting the respective uplink transmissions in the one or more uplink subbands of the one or more symbols based on one or more frequency resources of an SSB overlapping with at least one of a first set of resource blocks of the one or more uplink subbands or a second set of resource blocks of a guard band.

In aspect 24, the method of aspect 23 further includes receiving an indication of one or more resource blocks of the second set of resource blocks.

In aspect 25, the method of aspect 23 further includes receiving one or more indications of one or more resource blocks of the first set of resource blocks and a third set of resource blocks of one or more downlink subbands for respective symbols of the one or more symbols, and wherein the second set of resource blocks are located between the first set of resource blocks and the third set of resource blocks in frequency.

In aspect 26, the method of any of aspects 23-25 further includes that the SSB overlaps in frequency with a subset of resources of the first set of resource blocks, and wherein adjusting the respective uplink transmissions includes skipping transmitting the uplink transmission in resources overlapping with the subset of resources.

In aspect 27, the method of aspect 26 further includes that adjusting the respective uplink transmissions includes skipping transmitting the uplink transmission in the second set of resource blocks.

In aspect 28, the method of aspect 26 further includes that the SSB is non-overlapping in frequency with the first set of resource blocks and is overlapping with a first subset of resources of the second set of resource blocks, and wherein adjusting the respective uplink transmissions includes skipping transmitting the uplink transmission in resources overlapping with a second subset of resources of the first set of resource blocks, and respective quantities of resource blocks of the first subset of resources and the second subset of resources being a same quantity.

A 29 is an apparatus for wireless communication at a UE, comprising: one or more memories; and one or more processors coupled to the one or more memories and, based at least in part on information stored in the one or more memories, the one or more processors that, individually or in any combination, are operable to cause the UE to perform the method of any of aspects 1-28.
Aspect 30 is an apparatus for wireless communication at a UE, comprising: one or more memories; and one or more processors coupled to the one or more memories and, based at least in part on information stored in the one or more memories, the one or more processors that, individually or in any combination, are configured to cause the UE to perform the method of any of aspects 1-28.
Aspect 31 is an apparatus for wireless communication at a UE, comprising: one or more memories; and one or more processors coupled to the one or more memories and, the one or more processors, individually or in any combination, are configured to cause the UE to perform the method of any of aspects 1-28.
Aspect 32 is an apparatus for wireless communication at a UE, comprising: a processing system that includes processor circuitry and memory circuitry that stores code and is coupled with the processor circuitry, the processing system configured to cause the UE to perform the method of one or more of aspects 1-28.
Aspect 33 is an apparatus for wireless communication at a UE, comprising means for performing the method of any of aspects 1-28.

In aspect 34, the apparatus of any of aspects 29-33 further includes one or more antennas or one or more transceivers.
Aspect 35 is a computer-readable storage medium (e.g., a non-transitory computer-readable storage medium) storing computer executable code at a UE, the code when executed by at least one processor causes the UE to perform the method of one or more of aspects 1-28.
Aspect 36 is a method of wireless communication at a network node, comprising: configuring a time resource pattern including a first set of time resources and a second set of time resources that are non-overlapping in a time domain with the first set of time resources, each time resource of the first set of time resources configured with a SBFD configuration, and each time resource of the second set of time resources configured with a non-SBFD configuration; providing a SSB configuration including one or more periodic SSB occasions; and adjusting an SSB operation or an SBFD operation in one or more symbols including an SSB occasion overlapping with reception of an uplink transmission of the first set of time resources.

In aspect 37, the method of aspect 36 further includes that adjusting the SSB operation or the SBFD operation includes: skipping scheduling of uplink traffic for the one or more symbols.

In aspect 38, the method of aspect 36 further includes that adjusting the SSB operation or the SBFD operation includes: skipping transmission of a respective SSB in each SSB occasion of the one or more symbols.

In aspect 39, the method of any of aspects 36-38 further includes scheduling each SSB occasion of the one or more periodic SSB occasions to respective time resources of the second set of time resources.

In aspect 40, the method of aspect 36 further includes that adjusting the SSB operation or the SBFD operation includes: configuring respective time resources of the first set of time resources to avoid an overlap with each SSB occasion of the SSB configuration.

In aspect 41, the method of any of aspects 36-40 further includes that each time resource of the first set of time resources includes one or more uplink subbands and one or more downlink subbands overlapping in the time domain, wherein the method further includes obtaining an uplink communication associated with a first UE using the one or more uplink subbands of a first time resource of the time resource pattern; and providing a downlink communication associated with a second UE using the one or more downlink subbands of the first time resource.

In aspect 42, the method of any of aspects 36, 39, or 41 further includes providing an allocation of one or more uplink subbands for a UE for respective uplink transmissions in one or more time resources of the first set of time resources; providing a configuration for the UE to measure respective SSBs in the one or more periodic SSB occasions; and skipping the reception of the uplink transmission in the one or more uplink subbands at the one or more symbols.

In aspect 43, the method of any of aspects 36-42 further includes prioritizing SSB measurement in the one or more periodic SSB occasions of the one or more symbols or reception of the uplink transmission based on a rule, wherein the rule is based on one or more of: an SSB type for respective SSB occasions of the one or more symbols, an uplink channel scheduling type for the respective uplink transmissions of the one or more symbols, a reference signal scheduling type of the respective uplink transmissions of the one or more symbols, a measurement type for measurement of the respective SSBs of the one or more symbols, a cell type associated with the respective SSBs of the one or more symbols, an uplink transmission type of the respective uplink transmissions of the one or more symbols, a content type for the respective uplink transmissions of the one or more symbols, a physical channel type for the respective uplink transmissions of the one or more symbols, a QoS for the respective uplink transmissions of the one or more symbols, or an indication from the network node.

In aspect 44, the method of aspect 43 further includes that an aperiodic resource is associated with a higher priority level than a semi-persistent resource and a periodic resource.

In aspect 45, the method of aspect 43 or 44 further includes that the SSB type includes one of an aperiodic SSB, a semi-persistent SSB, or a periodic SSB.

In aspect 46, the method of any of aspects 43-45 further includes that the uplink channel scheduling type and the reference signal scheduling type include one of an aperiodic scheduling type, a semi-persistent scheduling type, or a periodic scheduling type.

In aspect 47, the method of any of aspects 43-46 further includes that the measurement type includes one of beam management, beam failure detection, radio link monitoring. PL, or radio resource management.

In aspect 48, the method of any of aspects 43-47 further includes that the cell type includes one of a serving cell or a non-serving cell.

In aspect 49, the method of any of aspects 43-48 further includes that the uplink transmission type includes one of a reference signal or a physical uplink channel.

In aspect 50, the method of any of aspects 43-49 further includes that the content type includes one of data or control information.

In aspect 51, the method of any of aspects 43-50 further includes that the physical channel type includes one of a PUCCH, a PUSCH, or a PRACH.

In aspect 52, the method of any of aspects 43-51 further includes that an aperiodic resource is associated with a higher priority level than a semi-persistent resource and a periodic resource.

In aspect 53, the method of any of aspects 43-52 further includes that the rule is based on an indication from the network node.

In aspect 54, the method of aspect 53 further include that the indication includes one or more of: a RRC indication that indicates prioritization for one of measuring the respective SSBs or transmitting the respective uplink transmissions, a MAC-CE indication indicating the prioritization for measuring the respective SSBs or transmitting the respective uplink transmissions, a GC DCI, a broadcast message, or a UE specific DCI.

In aspect 55, the method of any of aspects 36-54 further includes skipping the reception of the respective uplink transmissions in the one or more symbols based, at least in part, on a frequency separation between one or more resource blocks of the uplink transmission and one or more frequency resources of an SSB on each respective symbol.

In aspect 56, the method of any of aspects 36, 37, and 39-55 further includes providing an allocation of one or more uplink subbands for a UE for respective uplink transmissions in one or more time resources of the first set of time resources; providing a configuration for the UE to measure respective SSBs in the one or more periodic SSB occasions; and adjusting respective receptions of uplink transmissions in the one or more uplink subbands of the one or more symbols based on one or more frequency resources of an SSB overlapping with at least a first set of resource blocks of the one or more uplink subbands or a second set of resource blocks of a guard band.

In aspect 57, the method of aspect 56 further includes that the SSB overlaps in frequency with a subset of resources of the first set of resource blocks, and wherein adjusting the respective receptions includes skipping receiving the uplink transmission in resources overlapping with the subset of resources.

In aspect 58, the method of aspect 58 further includes adjusting the respective receptions includes skipping receiving the uplink transmission in the second set of resource blocks.

In aspect 59, the method of aspect 56 further includes that the SSB is non-overlapping in frequency with the first set of resource blocks and is overlapping with a first subset of resources of the second set of resource blocks, and wherein adjusting the respective receptions includes skipping receiving the uplink transmission in one or more guard band resources based on resources of the SSB.
Aspect 60 is an apparatus for wireless communication at a network node, comprising: one or more memories; and one or more processors coupled to the one or more memories and, based at least in part on information stored in the one or more memories, the one or more processors that, individually or in any combination, are operable to cause the network node to perform the method of any of aspects 36-59.
Aspect 61 is an apparatus for wireless communication at a network node, comprising: one or more memories; and one or more processors coupled to the one or more memories and, based at least in part on information stored in the one or more memories, the one or more processors that, individually or in any combination, are configured to cause the network node to perform the method of any of aspects 36-59.
Aspect 62 is an apparatus for wireless communication at a network node, comprising: one or more memories; and one or more processors coupled to the one or more memories and, the one or more processors, individually or in any combination, are configured to cause the network node to perform the method of any of aspects 36-59.
Aspect 63 is an apparatus for wireless communication at a network node, comprising: a processing system that includes processor circuitry and memory circuitry that stores code and is coupled with the processor circuitry, the processing system configured to cause the network node to perform the method of one or more of aspects 36-59.
Aspect 64 is an apparatus for wireless communication at a network node, comprising means for performing the method of any of aspects 36-59.

In aspect 65, the apparatus of any of aspects 60-64 further includes one or more antennas or one or more transceivers.
Aspect 66 is a computer-readable storage medium (e.g., a non-transitory computer-readable storage medium), storing computer executable code at a network node, the code when executed by at least one processor causes the network node to perform the method of one or more of Aspects 36-59.

What is claimed is:

1. An apparatus for wireless communication at a user equipment (UE), comprising:
one or more memories; and
one or more processors coupled to the one or more memories and, based at least in part on information stored in the one or more memories, the one or more processors that, individually or in any combination, are operable to cause the UE to:
receive a time resource pattern including a first set of time resources and a second set of time resources that are non-overlapping in a time domain with the first set of time resources, each time resource of the first set of time resources configured with a subband full-duplex (SBFD) configuration, and each time resource of the second set of time resources configured with a non-SBFD configuration;
receive a synchronization signal block (SSB) configuration including one or more periodic SSB occasions; and
adjust at least one of an SSB measurement or an uplink transmission in one or more symbols including an SSB occasion, of the one or more periodic SSB occasions, overlapping with a time resource of the first set of time resources.

2. The apparatus of claim 1, wherein each SSB occasion of the one or more periodic SSB occasions is included in the second set of time resources.

3. The apparatus of claim 1, wherein to adjust the at least one of the SSB measurement or the uplink transmission, the one or more processors are operable to cause the UE to skip the SSB measurement based on the SSB configuration.

4. The apparatus of claim 1, wherein to adjust the at least one of the SSB measurement or the uplink transmission, the one or more processors are operable to cause the UE to skip transmission of the uplink transmission in the one or more symbols including the SSB occasion.

5. The apparatus of claim 1, wherein the one or more processors are further operable to cause the UE to:
receive a configuration to measure respective SSBs in the one or more periodic SSB occasions, wherein to adjust the at least one of the SSB measurement or the uplink transmission, the one or more processors are operable to cause the UE to skip transmission of the uplink transmission in the one or more symbols including the SSB occasion.

6. The apparatus of claim 1, wherein the one or more processors are further operable to cause the UE to:
transmit the uplink transmission in the one or more symbols including the SSB occasion based on the UE being non-configured to perform the SSB measurement.

7. The apparatus of claim 1, wherein the one or more processors are further operable to cause the UE to:
receive a configuration to measure respective SSBs in the one or more periodic SSB occasions; and
receive an allocation of one or more uplink subbands to transmit respective uplink transmissions in one or more time resources of the first set of time resources.

8. The apparatus of claim 7, wherein the one or more processors are further operable to cause the UE to:
transmit the respective uplink transmissions in the one or more symbols including the SSB occasion, wherein to adjust the at least one of the SSB measurement or the uplink transmission, the one or more processors are operable to cause the UE to skip the SSB measurement in the one or more symbols.

9. The apparatus of claim 7, wherein the one or more processors are further operable to cause the UE to:
measure the respective SSBs in the one or more symbols including the SSB occasion, wherein to adjust the at least one of the SSB measurement or the uplink transmission, the one or more processors are operable to cause the UE to skip the respective uplink transmissions in the one or more symbols.

10. The apparatus of claim 7, wherein the one or more processors are further operable to cause the UE to:
prioritize transmission of the respective uplink transmissions in the one or more symbols or measuring the respective SSBs in the one or more symbols based on a rule.

11. The apparatus of claim 10, wherein the rule is based on one or more of:
an SSB type for respective SSB occasions of the one or more symbols,
an uplink channel scheduling type for the respective uplink transmissions of the one or more symbols,
a reference signal scheduling type of the respective uplink transmissions of the one or more symbols,
a measurement type for measurement of the respective SSBs of the one or more symbols,
a cell type associated with the respective SSBs of the one or more symbols, an uplink transmission type of the respective uplink transmissions of the one or more symbols,
a content type for the respective uplink transmissions of the one or more symbols, a physical channel type for the respective uplink transmissions of the one or more symbols, or
a quality of service (QOS) for the respective uplink transmissions of the one or more symbols.

12. The apparatus of claim 10, wherein the rule is based on an indication from a network node.

13. The apparatus of claim 12, wherein the indication includes one or more of:
a radio resource control (RRC) indication that indicates prioritization for one of measuring the respective SSBs or transmitting the respective uplink transmissions, a medium access control-control element (MAC-CE) indication indicating the prioritization for measuring the respective SSBs or transmitting the respective uplink transmissions,
a group common signaling downlink control information (GC DCI),
a broadcast message, or
a UE specific DCI.

14. The apparatus of claim 7, wherein to adjust the at least one of the SSB measurement or the uplink transmission, the one or more processors are operable to cause the UE to transmit or skip the respective uplink transmissions in the one or more symbols is based, at least in part, on a frequency separation between one or more resource blocks of the uplink transmission and one or more frequency resources of an SSB on each respective symbol.

15. The apparatus of claim 7, wherein to adjust the at least one of the SSB measurement or the uplink transmission, the one or more processors are operable to cause the UE to:
adjust the respective uplink transmissions in the one or more uplink subbands of the one or more symbols based on one or more frequency resources of an SSB overlapping with at least one of a first set of resource blocks of the one or more uplink subbands or a second set of resource blocks of a guard band.

16. The apparatus of claim 15, wherein the SSB overlaps in frequency with a subset of resources of the first set of resource blocks, and wherein to adjust the respective uplink transmissions, the one or more processors are operable to cause the UE to skip transmitting the uplink transmission in resources overlapping with the subset of resources.

17. The apparatus of claim 1, further comprising one or more antennas coupled to the one or more processors.

18. A method of wireless communication at a user equipment (UE), comprising:
receiving a time resource pattern including a first set of time resources and a second set of time resources that are non-overlapping in a time domain with the first set of time resources, each time resource of the first set of time resources configured with a subband full-duplex (SBFD) configuration, and each time resource of the second set of time resources configured with a non-SBFD configuration;
receiving a synchronization signal block (SSB) configuration including one or more periodic SSB occasions; and
adjusting at least one of an SSB measurement or an uplink transmission in one or more symbols including an SSB occasion, of the one or more periodic SSB occasions, overlapping with a time resource of the first set of time resources.

19. An apparatus for wireless communication at a network node, comprising:
one or more memories; and
one or more processors coupled to the one or more memories and, based at least in part on information stored in the one or more memories, the one or more processors, individually or in any combination, are operable to cause the network node to:
configure a time resource pattern including a first set of time resources and a second set of time resources that are non-overlapping in a time domain with the first set of time resources, each time resource of the first set of time resources configured with a subband full-duplex (SBFD) configuration, and each time resource of the second set of time resources configured with a non-SBFD configuration;
provide a synchronization signal block (SSB) configuration including one or more periodic SSB occasions; and
adjust an SSB operation or an SBFD operation in one or more symbols including an SSB occasion overlapping with reception of an uplink transmission of the first set of time resources.

20. The apparatus of claim 19, wherein to adjust the SSB operation or the SBFD operation the one or more processors are operable to cause the network node to:
skip scheduling of uplink traffic for the one or more symbols.

21. The apparatus of claim 19, wherein to adjust the SSB operation or the SBFD operation the one or more processors are operable to cause the network node to:
skip transmission of a respective SSB in each SSB occasion of the one or more symbols.

22. The apparatus of claim 19, wherein to adjust the SSB operation or the SBFD operation the one or more processors are operable to cause the network node to:
configure respective time resources of the first set of time resources to avoid an overlap with each SSB occasion of the SSB configuration.

23. The apparatus of claim 19, wherein each time resource of the first set of time resources includes one or more uplink subbands and one or more downlink subbands overlapping in the time domain, wherein the one or more processors are further operable to cause the network node to:
obtain an uplink communication associated with a first user equipment (UE) using the one or more uplink subbands of a first time resource of the time resource pattern; and
provide a downlink communication associated with a second UE using the one or more downlink subbands of the first time resource.

24. The apparatus of claim 19, wherein the one or more processors are further operable to cause the network node to:
provide an allocation of one or more uplink subbands for a user equipment (UE) for respective uplink transmissions in one or more time resources of the first set of time resources;
provide a configuration for the UE to measure respective SSBs in the one or more periodic SSB occasions; and
skip the reception of the uplink transmission in the one or more uplink subbands at the one or more symbols.

25. The apparatus of claim 24, wherein the one or more processors are further operable to cause the network node to:
prioritize SSB measurement in the one or more periodic SSB occasions of the one or more symbols or the reception of the uplink transmission based on a rule, wherein the rule is based on one or more of:
an SSB type for respective SSB occasions of the one or more symbols,
an uplink channel scheduling type for the respective uplink transmissions of the one or more symbols,
a reference signal scheduling type of the respective uplink transmissions of the one or more symbols,
a measurement type for measurement of the respective SSBs of the one or more symbols,
a cell type associated with the respective SSBs of the one or more symbols,
an uplink transmission type of the respective uplink transmissions of the one or more symbols,
a content type for the respective uplink transmissions of the one or more symbols,
a physical channel type for the respective uplink transmissions of the one or more symbols,
a quality of service (QOS) for the respective uplink transmissions of the one or more symbols, or
an indication from the network node.

26. The apparatus of claim 25, wherein the rule is based on the indication from the network node, wherein the indication includes one or more of:
a radio resource control (RRC) indication that indicates prioritization for respective SSB measurements instead of the respective uplink transmissions,
a medium access control-control element (MAC-CE) indication indicating the prioritization for one or more SSB occasions of the one or more periodic SSB occasions,
a group common signaling downlink control information (GC DCI),
a broadcast message, or
a UE specific DCI.

27. The apparatus of claim 25, wherein the one or more processors are configured to skip the reception of the respective uplink transmissions in the one or more symbols is based, at least in part, on a frequency separation between one or more resource blocks of the uplink transmission and one or more frequency resources of an SSB on each respective symbol.

28. The apparatus of claim 19, wherein the one or more processors are further operable to cause the network node to:
provide an allocation of one or more uplink subbands for a user equipment (UE) for respective uplink transmissions in one or more time resources of the first set of time resources;
provide a configuration for the UE to measure respective SSBs in the one or more periodic SSB occasions; and
adjust respective receptions of uplink transmissions in the one or more uplink subbands of the one or more symbols based on one or more frequency resources of an SSB overlapping with at least a first set of resource blocks of the one or more uplink subbands or a second set of resource blocks of a guard band.

29. The apparatus of claim 19, further comprising one or more antennas coupled to the one or more processors.

30. A method of wireless communication at a network node, comprising:
configuring a time resource pattern including a first set of time resources and a second set of time resources that are non-overlapping in a time domain with the first set of time resources, each time resource of the first set of time resources configured with a subband full-duplex (SBFD) configuration, and each time resource of the second set of time resources configured with a non-SBFD configuration;
providing a synchronization signal block (SSB) configuration including one or more periodic SSB occasions; and
adjusting an SSB operation or an SBFD operation in one or more symbols including an SSB occasion overlapping with reception of an uplink transmission of the first set of time resources.
